(19) United States
(12) Patent Application Publication
(10) Pub. No.: US 2026/0152059 A1
(43) Pub. Date: Jun. 4, 2026

(54) MULTI-SPEED E-AXLE WITH INTEGRATED ELECTRIC MOTOR AND SHIFT MECHANISM

(71) Applicant: Dana Belgium N.V., Brugge (BE)

(72) Inventors: Bert HANNON, Brugge (BE); Chun ZHANG, Wuxi (CN); Yang LIU, Wuxi (CN); Willem MARISSENS, Brugge (BE)

(21) Appl. No.: 18/968,245

(22) Filed: Dec. 4, 2024

(51) Int. Cl. B60K 23/04; F16H 1/46; F16H 61/00

(52) U.S. Cl. CPC B60K 23/04; F16H 1/46; F16H 61/0009; B60Y 2300/18116; B60Y 2300/28

(57) ABSTRACT

A configuration of an electric axle comprising: a first clutch configured to ground a ring gear in a first planetary gearset; a second clutch configured to: ground a carrier in a second planetary gearset; and drivingly couple an input of the first planetary gearset to an output of the second planetary gearset to bypass the first planetary gearset; one or more park brakes configured to ground one or more shafts to an axle housing of the electric axle; and a controller configured to: in a hill hold mode, engage the first clutch, the second clutch, and the one or more park brakes; and in disconnect mode, disengage the first clutch, the second clutch, and the one or more park brakes, where the disconnect mode is a towing state allowing for towing.

### TECHNICAL FIELD

The present description relates generally to an e-axle with an integrated transmission and electric motor, where the transmission is a two speed transmission housing a plurality of planetary gearsets with gears selectable via wet clutches.

### BACKGROUND AND SUMMARY

An electric vehicle, such as a fully electric vehicle (FEV) or hybrid electric vehicle (HEV), comprises an electrified driveline. HEVs may operate in different modes using different energy sources (e.g., hybrid electric, battery electric and engine only). An electric vehicle may be an off highway (OF) vehicle with off highway applications. Off highway vehicles may either have a central transmission or be single speed, for example.

Central transmissions and the drive shafts connecting them to one or more axles may take up space (e.g., packing space) in a vehicle, such as space enclosed within or housed by the vehicle. Heavy off highway applications typically require a high maximum tractive effort and a relatively high max speed. To meet maximum tractive effort and top speed for heavy off highway applications, the electric machine in a single speed e-driveline may be drastically oversized from a perspective of electrical power consumed and rotational power generated to produce a great enough torque for to meet a first threshold of traction and rotate at a great speed to meet a second threshold of rotational speed.

Oversizing an electric machine may increase the quantity of materials used and/or the time and labor for manufacturing, which may increase the cost of the electric machine. Additionally, oversizing the electric machine may decrease power efficiency (e.g., conversion of electrical power to rotational energy and other mechanical energy output via the electric machine). The oversized electric machine may therein have a poor efficiency region. Further, multi-speed distributed systems are often difficult to package, e.g., finding packing spaces and other volumes of a vehicle that may house the components of the multi-speed distributed systems. Components, such as gears and clutches, are to be located between the wheels where a desired track width and a desired ground clearance may impose hard constraints. For example, e-axles of a t-shaped configuration may have a large bevel gear to meet desired torque and speed, and the large bevel gear may occupy an undesired amount of packing space and may contribute to energy losses for the e-axle.

It may be desired to have a vehicle with tighter or less conventional packing space and other volumes to house components of the multi-speed distributed systems. Further still, it may be desired to have e-axles with an additional disconnect allowing towing of trailer or another load at high speeds. It may also be desired to the have e-axles provide a torque-free safe state that is achieved absent the inverter (e.g., where the inverter is not relied upon to engage the torque-free safe state) and absent an additional disconnect (e.g., a disconnect, such as a clutch, separate from the disconnects of the transmission). Additionally, it may be desired to have an off-highway vehicle with an e-axle of a T-shaped configuration, where a motor (e.g., such as the electric machine) or another mover is positioned perpendicularly with respect to the axle).

The inventors have recognized the above issues as well as drawbacks of using a central transmission or using a single speed transmission for an electrified driveline, such as those described above. The inventors have developed a configuration of an electric axle comprising: a first clutch configured to ground a ring gear in a first planetary gearset; a second clutch configured to: ground a carrier in a second planetary gearset; and drivingly couple an input of the first planetary gearset to an output of the second planetary gearset to bypass the first planetary gearset; one or more park brakes configured to ground one or more shafts to an axle housing of the electric axle; and a controller configured to: in a hill hold mode, engage the first clutch, the second clutch, and the one or more park brakes; and in disconnect mode, disengage the first clutch, the second clutch, and the one or more park brakes, where the disconnect mode is a towing state allowing for towing.

The integrated motor of the electric axle may omit a bevel gear, reducing a threshold of packing space for holding the axle. A carrier of at least a planetary gear connects to a differential of the electric axle, such as to drive a differential carrier or a similar component of the differential attached to the differential gears. The differential may in turn drive the sun gears of the hub drives via shafts, where each shaft may rigidly couple or selectively couple a sun gear of the hub drives. The hub drive is a standard hub drive allowing for commonality between the e-axle and the traditional axle. Its ring gear is blocked (fixed to the axle housing), the carrier drives the wheels. A service brake is foreseen on the sun.

Aside from the above-described axle with integrated motor and shift mechanism, the system may also contain an electronic control unit to control and actuate the system and a pump assembly that provides oil for lubrication and actuation. Multiple variants may allow for different packaging needs and higher or lower ratios (speeds). For example, alternatively another configuration of electric axle may only have a first clutch and a second clutch to selectively couple the first planetary gearset to other components of an axle, with the second planetary gearset absent or present but absent clutches. For this example, at least a clutch of the first clutch or the second clutch is configured to selectively couple the first carrier of the first planetary gearset and drivingly couple an input of the first planetary gearset the differential carrier, such as to drive the differential carrier via the input.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows a schematic diagram of an electrical drive train (e-drive) of a vehicle.

FIG. 2 shows a schematic diagram of a first example of an e-drive comprising an e-axle.

FIG. 3 shows a schematic diagram of a second example of an e-drive comprising an e-axle.

FIG. 4 shows a schematic diagram of a third example of an e-drive comprising an e-axle.

FIG. 5 shows a schematic diagram of a fourth example of an e-drive comprising an e-axle.

FIG. 6 shows a table of transmission states and vehicle modes selectable via one or more e-axles of the present disclosure.

FIG. 7 illustrates a method for switching between different modes of operation for the e-axle.

FIG. 8 illustrates a method for selecting between different gear modes during a driving operation.

FIG. 9 shows a transmission system and a pump assembly, the pump assembly is fluidically coupled to a lubrication circuit and an actuation circuit.

FIG. 10A show the plurality of valves of the transmission system and the pump assembly open in a first arrangement.

FIG. 10B show the plurality of valves of the transmission system and the pump assembly open in a second arrangement.

### DETAILED DESCRIPTION

The following description relates to a one or more configurations of an electrified axle that may be referred to herein as an electric axle or e-axle for short. An electrified driveline, referred to herein as an e-drive, comprises the e-axle, where the drive components of the driveline are fixed to or housed by the e-axle. The electric machine may be an electric motor or an electric motor generator that may drive the e-axle. The e-axle comprises a plurality of planetary gearsets. The transmission specifically, comprises a plurality of planetary gearsets. The e-axle also houses and integrates a differential and differential gearset therein. The e-axle may include two shafts each drivingly coupled to wheels.

Each of the two shafts may drivingly couple to wheels via a final drive. For example, each of the two shafts may selectively couple to wheels via a final drive. When selectively coupled via a final drive, a shaft of the e-axle may couple one or more wheels via a planetary gearset specific to the final drive. The final drives may be hub drives. The differential may drive the sun gears of the final drives via shafts, where each shaft may rigidly couple or selectively couple a sun gear of the final drives. The hub drive is a standard hub drive allowing for commonality between the e-axle and the traditional axle. The components of the e-axle may be housed in a housing, referred to as an axle housing.

The electric machine may omit a bevel gear as an output. Said in another way, the e-axle may omit a set of bevel gears that couple the electric machine to the differential, such that the electric machine may drive the differential. The omission of at least a bevel gear or a plurality of bevel gears of a set of bevel gears may reduce a threshold of packing space for holding the axle. Instead the electric machine couple the differential via one or more of the planetary gearsets, such that the electric machine may drive the differential. A coupling where a first component or feature is coupled to drive a second component or feature or vice versa, may be referred to herein as a drive coupling. Said in another way, coupling the first component or feature to the second component or feature to drive one another, may be referred to as drivingly coupling the first component or feature and the second component or feature.

The electric machine and the transmission may drivingly couple to the differential and differential gearset such as to transmit rotational energy, such as via torque, to the differential. For example, the electric machine may drive the differential via the transmission. For example, outputs from the transmission may couple to the differential carrier of the differential, such that the differential carrier is driven and spun via rotational energy generated via the electric machine. The rotation and spinning of the differential carrier may therein drive the differential gears and the side gears. The side gears may rigidly couple to the axle shafts of the e-axle, allowing for the driving of the wheels via the axle therein.

The transmission is a two speed transmission, having two gear speeds (e.g., gear ratios) housing a plurality of planetary gearsets with gears selectable via clutches. The clutches may be wet clutches. A first gear clutch of the clutches may be engaged to select a first gear speed for the transmission. The first gear clutch selectively fixes a first ring gear of a planetary gearset to the axle housing or deselects allowing free rotation of the planetary gearset from the axle housing. A second gear clutch may be engaged to select a second gear speed for the transmission. The first gear clutch and the second gear clutch may also be brakes for the differential, that when engaged stop the transfer of and rotation of gears of the differential therein. More specifically the first gear clutch may be a brake for the differential carrier, stopping rotation of the differential carrier.

The following description also shows a method for switching between different modes of operation for the e-axle. Modes of operation include a mode for engaging the e-axle in a neutral state, a mode of driving operation, a mode for engaging a hill hold feature, modes engaging a safe state and/or towing state, and a mode for engaging a park brake. The towing state may be a disconnect mode, where no clutches are engaged and the wheels of an axle may rotate independently of the axle shafts, gears of the differential, and the gears of the transmission. The method also includes selecting between different gear modes during a driving operation.

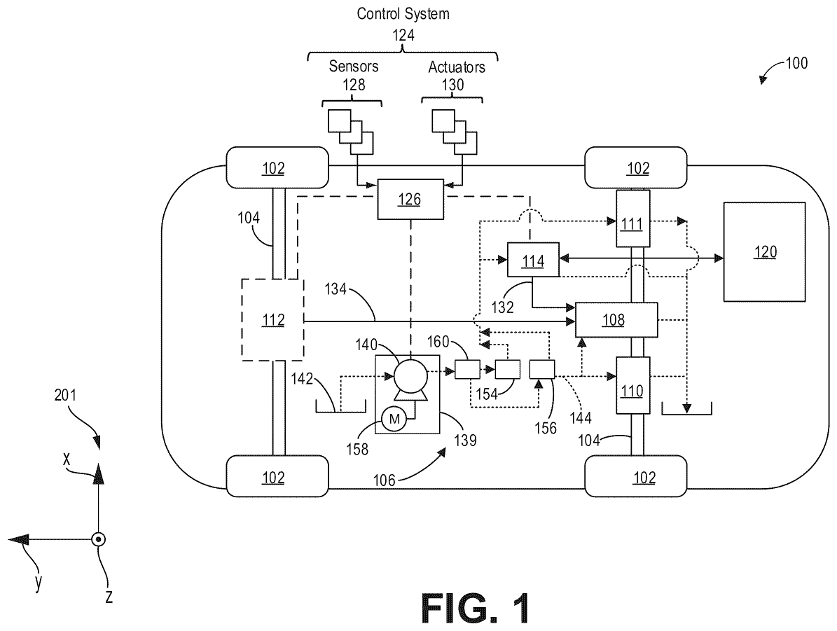

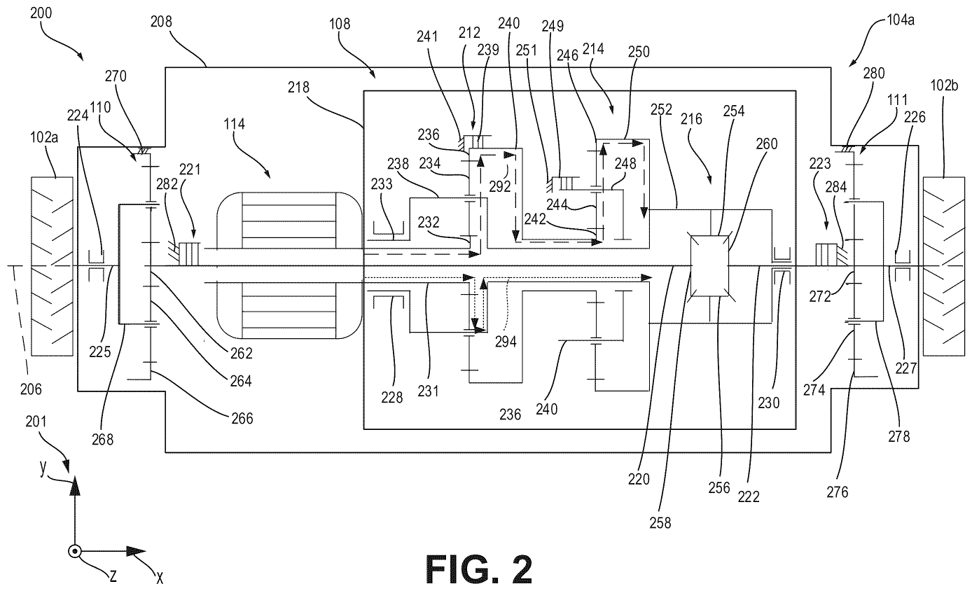

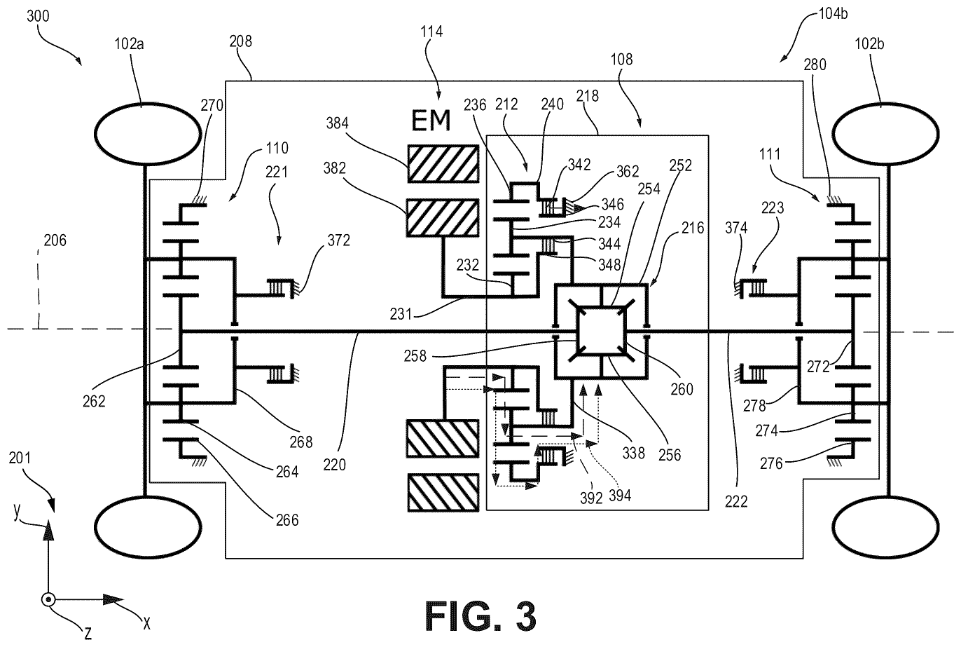

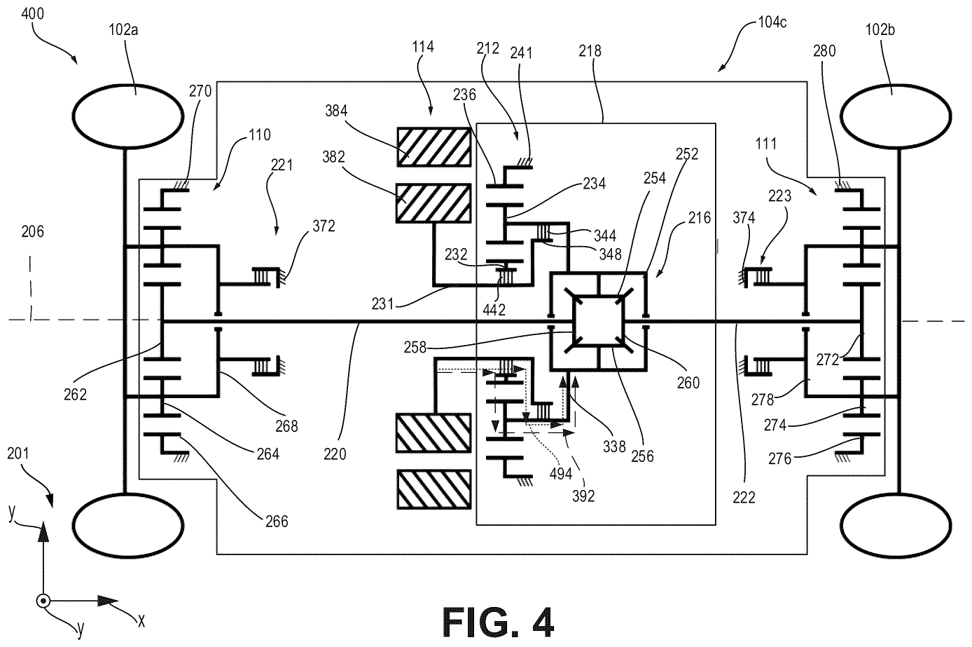

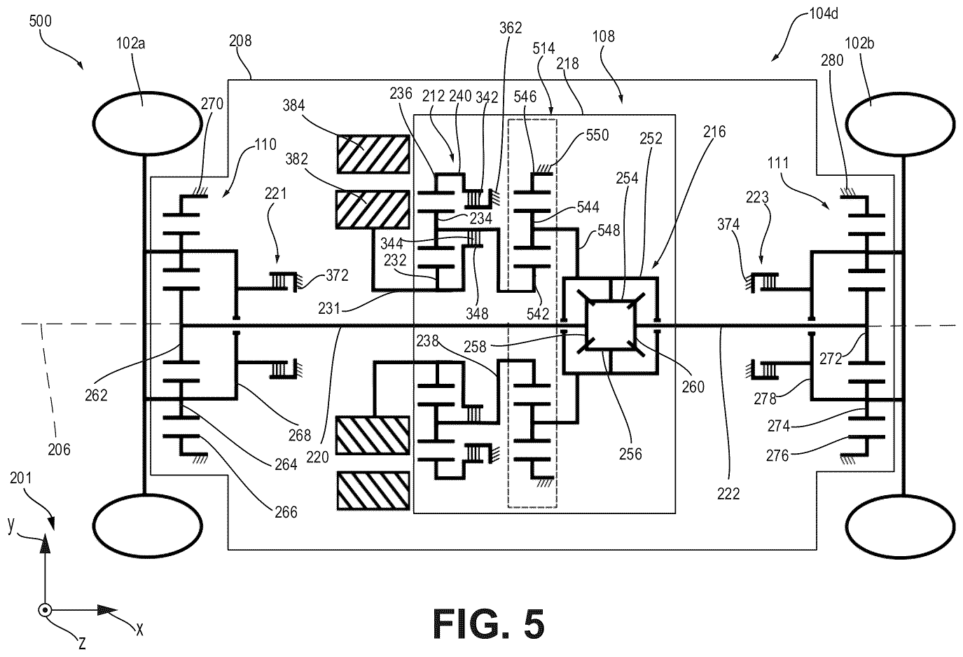

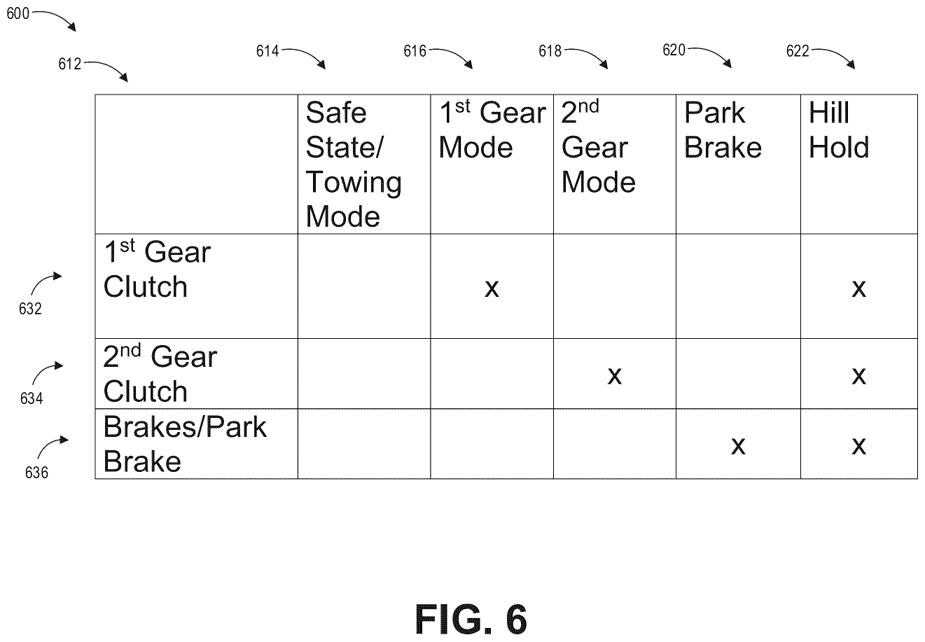

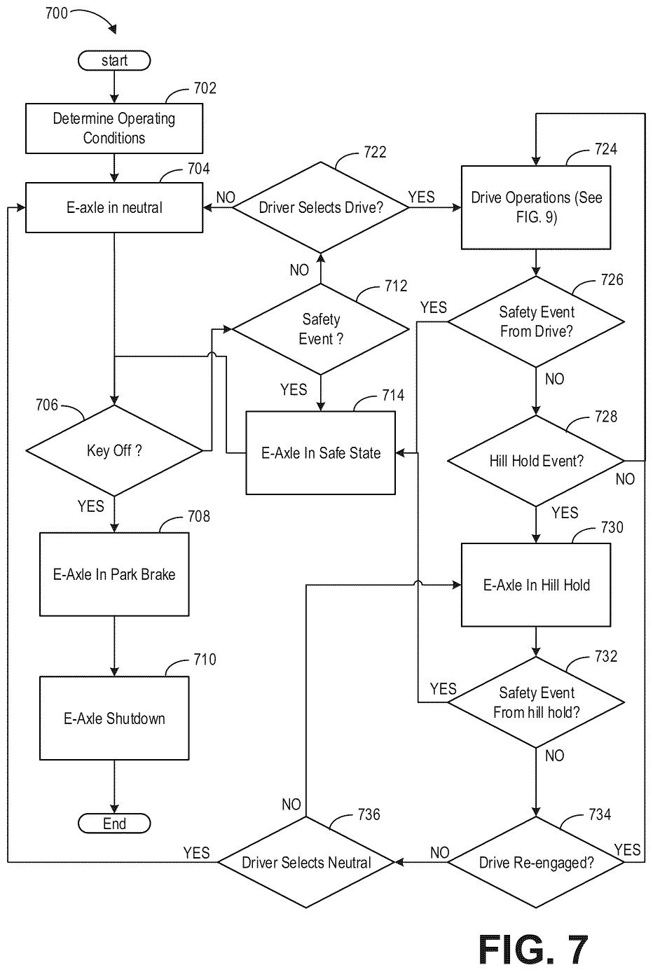

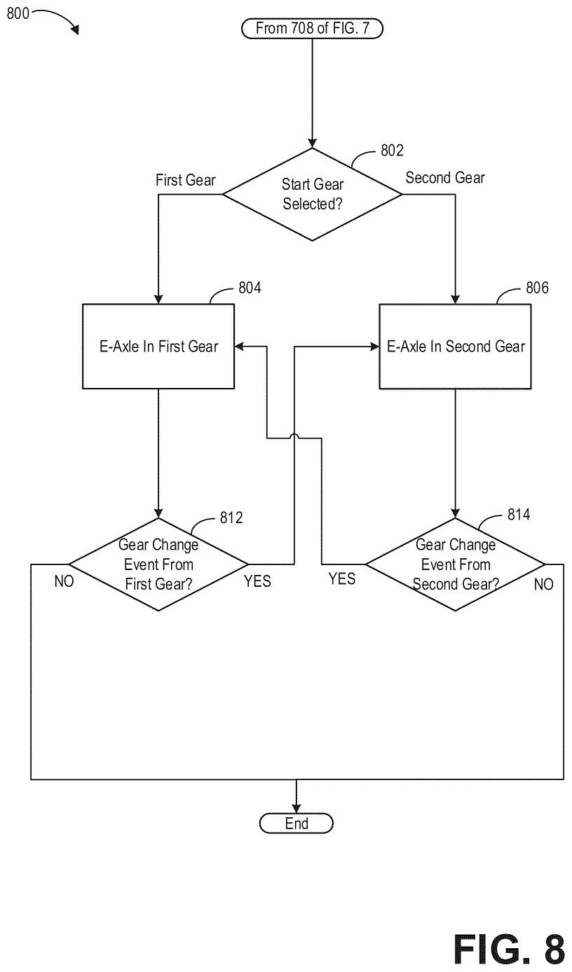

FIG. 1 shows a schematic diagram of an electrical drive train (e-drive) of a vehicle. FIG. 2 shows a schematic diagram of a first configuration of an e-axle with an integrated e-drive. FIG. 3 shows a schematic diagram of a second configuration of an e-axle with an integrated e-drive. FIG. 4 shows a schematic diagram of a third configuration of an e-axle with an integrated e-drive. FIG. 5 shows a schematic diagram of a fourth configuration of an e-axle with an integrated e-drive. The e-drives of FIGS. 2-5 may include at least an electric machine and a transmission integrated into their respective configurations of e-axles and coupled to a differential of the axle such as to transmit rotational energy therein. More specifically, the electric machine is arranged to generate and transmit rotational energy, such as via torque, to the transmission, and the transmission transmits rotational energy to the differential. FIG. 6 shows a table of transmission states and vehicle modes selectable via one or more e-axles of the present disclosure. FIG. 7 illustrates a method for switching between different modes of operation for the e-axle. FIG. 8 illustrates a method for selecting between different gear modes during a driving operation.

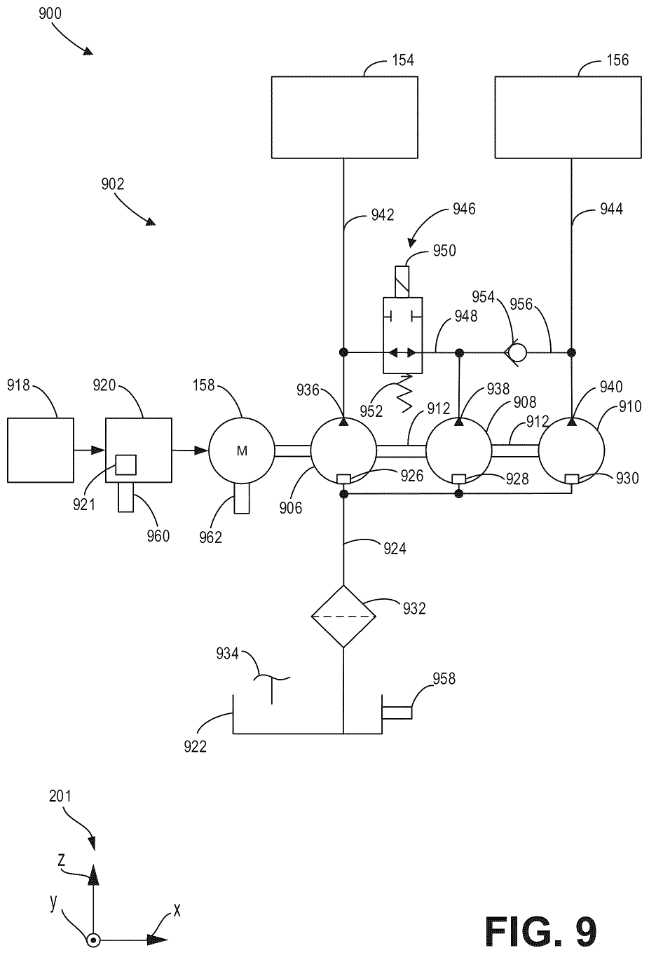

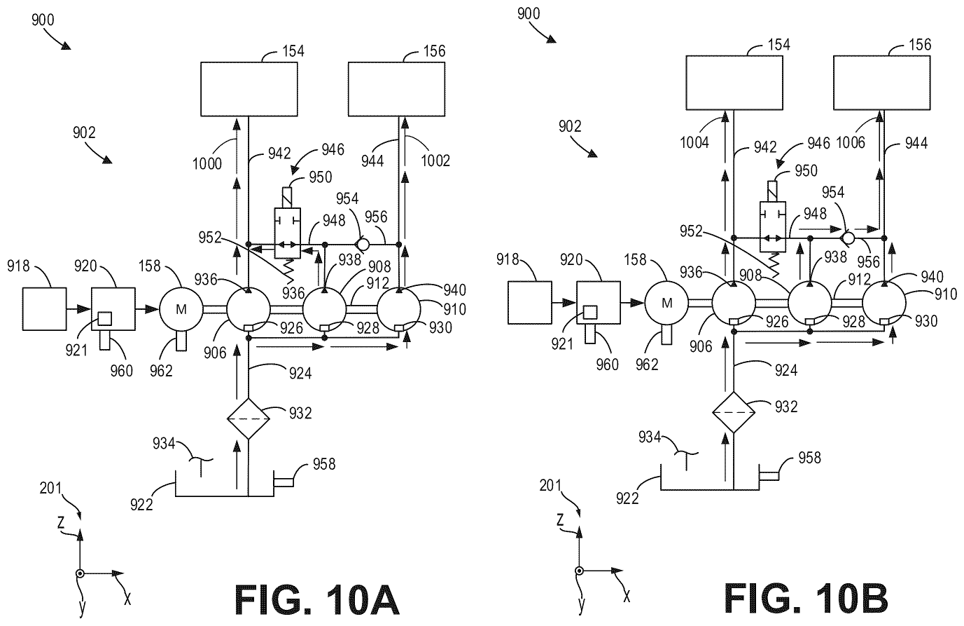

FIG. 9 shows a transmission system and a pump assembly, the pump assembly is fluidically coupled to a lubrication circuit and an actuation circuit. The transmission system may include the transmission of the e-axle. The lubrication circuit may lubricate the clutches, brakes, bearings, shafts, and a plurality of other components of the transmission and the e-axle. The actuation circuit may actuate the clutches and brakes of transmission and the e-axle. FIG. 10A show the plurality of valves of the transmission system and the pump assembly open in a first arrangement. The first arrangement may be used for lubrication operations at a desired regime speed when driving the wheels of the vehicle and/or when transitioning between clutch states, brake states, hill hold states, or other vehicle states is prevented. FIG. 10B show the plurality of valves of the transmission system and the pump assembly open in a second arrangement. The second arrangement may be strategically adjusted to meet flow demands of the actuation circuit during transient conditions (e.g., shift events). During shift events, one or more clutches and/or brakes may be actuated to engage or disengage (e.g., open or close). Shift events may occur when transitioning the e-axle to different gear speed states, different brake states, a hill hold state, or other vehicle states.

A set of reference axes 201 are provided for comparison between views shown in FIGS. 1-5 and FIGS. 9-10B, for reference. The reference axes 201 indicate a y-axis, an x-axis, and a z-axis. The z-axis may be a vertical axis (e.g., parallel to a gravitational axis), the x-axis may be a lateral axis (e.g., horizontal axis), and/or the y-axis may be a longitudinal axis, in one example. However, the axes may have other orientations, in other examples. The x-y plane may be parallel with a plane that e-axles of the present disclosure, such as examples of e-axle 104, may rest upon. When referencing direction, positive may refer to in the direction of the arrow of the y-axis, x-axis, and z-axis and negative may refer to in the opposite direction of the arrow of the y-axis, x-axis, and z-axis. A filled circle may represent an arrow and axis facing toward, or positive to, a view. An unfilled circle may represent an arrow and an axis facing away, or negative to, a view.

Turning now to FIG. 1, it shows a schematic representation of an electrified vehicle 100 (e.g., an electric vehicle). The vehicle 100 may be fully electric vehicle (FEV) that may be provided with at least a single source of torque from an electric machine (EM) (e.g., an electromagnetic device). The vehicle 100 may be a hybrid electric vehicle (HEV) with multiple sources of torque that may be provided to a vehicle's wheels from more than one source, including from one or more electric other electric machines, one or more hydraulic motors, one or more internal combustion engines (ICEs), one or more other fuel burning engine, and/or a combination of the like. The vehicle 100 may be a commercial vehicle, light, medium, or heavy duty vehicle, a passenger vehicle, an off-highway vehicle, and sport utility vehicle. Additionally or alternatively, the vehicle 100 and/or one or more of its components, such as one or more of a plurality of axles 104, may be for industrial, locomotive, military, agricultural, and aerospace applications.

A schematic representation of a vehicle 100 is depicted in FIG. 1 which includes sets of wheels 102 coupled by axles 104 (e.g., pairs of wheels are coupled to one another by the axles 104). It will be appreciated that vehicle 100 is shown in FIG. 1 for illustrative purposes and is a non-limiting example of how a housing of an electric vehicle 100 and an axle of the present disclosure may be configured upon integrating with the electric vehicle 100. Other examples include various arrangements and positioning of components of the vehicle described below as well as additional components not shown in FIG. 1 for brevity.

A drive train 106 of vehicle 100 may include a transmission 108 (e.g., a gear box, gear train, etc.) coupled to one or more of the axles 104 of vehicle 100. The transmission 108 may be coupled to a rear axle of the axles 104, as shown in FIG. 1. Alternatively, the transmission 108 and/or another transmission of the present disclosure may be coupled to a front axle or to both axles of the axles 104, in other examples. For examples, where transmissions of the present disclosure are coupled to both axles of the axles 104, there may be a transmission of the present disclosure coupled to each axle of the axles 104.

The transmission 108 may be mechanically coupled to a first final drive 110 and a second final drive 111 of the drive train 106. Said in another, way the transmission 108 may drivingly couple the first final drive 110 and the second final drive 111. The transmission 108, and/or the first final drive 110 and second final drive 111 may together translate speed and torque from a rotating source to the vehicle wheels 102 to propel vehicle 100. The present configuration includes at least an input to the transmission 108, such as a first transmission input shaft 132, coupling at least an electric machine 114 and the transmission 108. Likewise, there may be a plurality of other electric machines with other inputs to the transmission 108. The present configuration may include another input to the transmission, such as a second transmission input shaft 134, coupling an engine 112 and the transmission 108. The second transmission input shaft 134 may drivingly couple the engine 112 to transmission 108 and/or an axle of the axle 104. For example, the engine 112 may couple a drive axle of the axles 104 via a differential, such that the engine 112 may drive the differential and the drive axle via the differential. The differential may also be coupled to the transmission 108, such that one or more other movers may drive the differential via the transmission. The one or more other movers may include the electric machine 114. In off-highway vehicle applications, a propshaft (not shown) may be included to mechanically couple, such as via drivingly coupling, the output of the transmission 108 to an input of an axle, such as one of the axles 104.

When configured as an HEV, the rotating sources of rotational power may include the electric machine 114 and the engine 112. The engine 112 may be an internal combustion engine or any other element which may provide rotational power to the transmission shaft.

In some examples, and as described herein, the electric machine 114 may be an electric motor or an electric motor/generator, with a capacity to convert electrical energy into mechanical energy and vice versa. As such, the electric machines may hereafter also be referred to as motors and/or generators. The electric machine 114 may be configured to operate in a generator mode and/or a motor mode. In a generator mode, propulsion system of the drive train 106 receives some or all of the output from electric machine 114, which reduces the amount of drive output or the amount of braking torque delivered to one or more drive wheels of wheels 102. Operations of the vehicle 100 that use the generator mode may be employed, for example, to achieve energy efficiency gains through regenerative braking, increased engine efficiency (if included), etc.

The electric machine 114 may be electrically coupled to an energy storage device or a plurality of energy storage devices. The electric machine 114 may draw power from or provide electrical energy to be stored via the one or more energy storage devices. For example, the electric machine 114 may electrically couple to a traction battery 120 of vehicle 100. The electric machine 114 may draw power from the traction battery 120 and provide electrical energy to be stored at the traction battery 120. For example, the traction battery 120 may be a high-voltage battery. In some embodiments, the traction battery 120 may be a generic DC-supply, such as a fuel cell or other power supply. The electric machines may be similarly configured, e.g., having similar operational speed and torque ranges, and thereby referred to as symmetric, or may have different speed and torque outputs, thereby referred to as asymmetric.

Adjustment of the drive train between the various modes as well as control of operations within each mode may be executed based on a vehicle control system 124, including a controller 126, as shown in FIG. 1. Controller 126 may be a microcomputer, including elements such as a microprocessor unit, input/output ports, an electronic storage medium for executable programs and calibration values, e.g., a read-only memory chip, random access memory, keep alive memory, and a data bus. The storage medium can be programmed with computer readable data representing instructions executable by a processor for performing the methods described below as well as other variants that are anticipated but not specifically listed. In one example, controller 126 may be a powertrain control module (PCM).

Controller 126 may receive various signals from sensors 128 coupled to various regions of vehicle 100. For example, the sensors 128 may include sensors at the electric machine 114 to measure motor speed and motor temperature, a pedal position sensor to detect a depression of an operator-actuated pedal, such as an accelerator pedal or a brake pedal, speed sensors at the vehicle wheels 102, and so on. Vehicle acceleration is directly proportional to accelerator pedal position, for example, degree of depression. Upon receiving the signals from the various sensors 128 of FIG. 1, controller 126 processes the received signals, and employs various actuators 130 of vehicle 100 to adjust drive train operations based on the received signals and instructions stored on the memory of controller 126. Controller 126 may actuate the various actuators 130 via a plurality of command signals. For example, controller 126 may receive an indication of depression of the brake pedal, signaling a desire for decreased vehicle speed. In response, controller 126 may command operation of at least one of the electric machines as a generator to recharge the traction battery 120.

A pump assembly (e.g., a pump system) 139 may provide fluid for lubrication and for actuation of components of the axle, referred to herein as a working fluid. The pump assembly 139 may include at least a pump 140 that pumps the working fluid to the gear sets and clutches of the transmission. Said in another way, the pump 140 is a hydraulic pump. The pump 140 may also pump the working fluid to the electric machine 114. It is to be appreciated that the pump assembly 139 may include a plurality of hydraulic pumps. The working fluid pumped by the pump 140 and/or other hydraulic pumps of the pump assembly 139 may be a lubricant for lubrication and a hydraulic fluid for actuation of components, such as clutches, actuators, and/or gears. For example, the working fluid may be oil. The pump assembly is designed to deliver working fluid (e.g., oil) to a lubrication circuit 154 and an actuation circuit 156 for the transmission 108. The entirety of or portions of the lubrication circuit 154 and/or actuation circuit 156 may be housed via the transmission 108. Likewise, the entirety of or portions of the pump assembly 139 may be housed via the transmission 108.

The pump assembly 139 may include a motor 158. The motor 158 may be an electric motor. Additionally or alternatively, the motor 158 may also be another type of electric machine, such as an electric motor or an electric motor generator. The motor 158 may be arranged to drive one or more pumps of the pump assembly 139. For example, the motor 158 may be arranged to drive at least the pump 140. The pump assembly 139 may include a plurality of pumps which are shown and expanded upon herein in relation to the FIGS. 9, 10A, and 10B. One or more hydraulic lines of a plurality of hydraulic lines and/or other suitable conduits represented by a plurality of dotted lines 144 establish fluidic communication between the pump assembly 139 and the lubrication circuit 154 as well as the actuation circuit 156.

It is to be appreciated that for another arrangement of the vehicle 100, one or more other motors may be used additionally or alternatively in place of motor 158 to drive the one or more pumps of the pump assembly 139. For another example, of another arrangement of the vehicle 100, the pump assembly 139 may include the electric machine 114, where the electric machine 114 may be arranged to drive one or more pumps of the pump assembly 139. Said in another way, the electric machine 114 may drive at least the pump 140, creating suction therein.

The lubrication circuit 154 includes suitable components (e.g., lubricant lines, conduits, nozzles, and the like) for delivering lubricant (e.g., oil) to transmission system components such as bearings, shafts, gears, clutches, brakes when the transmission uses a planetary gearset design, and the like of the transmission 108. The actuation circuit 156 delivers working fluid to transmission components such as clutches, brakes, shift rails, and the like of the transmission 108.

Lubricant may be directed from the pump 140 and pump assembly 139 to at least a hydraulic valve block 160. The hydraulic valve block 160 comprises a plurality of valves that may be opened to direct working fluid or opened and partially opened to increase pressure to specific fluid channels or other suitable conduits. The valves of the hydraulic valve block 160 may be closed to prevent fluid flow or closed and partially closed to reduce pressure of working fluid to specific fluid channels or other suitable conduits. The valves of the hydraulic valve block 160 may be opened or closed via the various actuators 130. The valves of the hydraulic valve block 160 may therein be opened or closed via command signals from the controller 126.

The valves of the hydraulic valve block 160 may be configured to hydraulically control the first clutch, the second clutch, and one or more park brakes. For example, valves of the hydraulic valve block 160 may open to increase pressure to fluid channels of the lubrication circuit. For this or another example, valves of the hydraulic valve block 160 may open to increase pressure to channels of the actuation circuit. More specifically, valves of the hydraulic valve block 160 may open to increase pressure to specific channels of the actuation circuit to actuate specific components fluidly coupled thereto. The hydraulic valve block 160 may open and close valves to engage or disengaged (open or close, respectively) plurality of clutches and one or more parking brakes of the transmission 108. Likewise, the hydraulic valve block 160 may open and close valves to engage or disengage at least a brake and/or clutch of the first final drive 110 and the second final drive 111. The opening and closing of valves of the hydraulic valve block 160 may be controlled via the control system 124 and/or the controller 126.

A working fluid pumped by the pump may lubricate and/or actuate components of the axles 104, the transmission 108, the first final drive 110, and the second final drive 111. For example, the pump may lubricate and actuate one or more wet clutches of the transmission 108, the first final drive 110, and the second final drive 111. The pump assembly 139 and/or another pump system may include or be fluidly coupled to a sump 142. The pump 140 may draw the working fluid from the sump 142. Fluid flow of the working fluid may be represented via a plurality of dotted lines 144. Fluid flow represented by dotted lines 144 may be carried via fluid lines, such as via pipes, tubing, or fluid passages. The dotted lines 144 have arrows showing directionality of flow of the working fluid. The dotted lines 144 show the working fluid may be returned to the sump 142 after lubricating and/or actuating one or more components and features of the axle 104, the transmission 108, the first final drive 110, and/or the second final drive 111.

A schematic example of a pump assembly that may be the pump assembly 139 is shown in FIG. 9.

A schematic of an e-drive 200 shown by FIG. 2, a schematic of an e-drive 300 shown by FIG. 3, a schematic of an e-drive 400 shown by FIG. 4, a schematic of an e-drive 500 shown by FIG. 5 may illustrate example arrangements of the drive train 106 and axles 104 of FIG. 1 in further detail. It will be appreciated that components of the e-drive 200, the e-drive 300, the e-drive 400, and the e-drive 500 having substantially similar function to components of the drive train 106 may be labeled with corresponding numbers.

Turning to FIG. 2, it shows a schematic of an e-drive 200. The e-drive 200 is a first configuration of an axle mounted or housed e-drive of the present disclosure comprising an e-axle 104a. The e-drive 200 may include a first wheel 102a and second wheel 102b. The e-axle 104a may couple to the first wheel 102a and a second wheel 102b, such the first wheel 102a and the second wheel 102b may be driven via the e-axle 104a. The wheels of the first wheel 102a and the second wheel 102b are located at opposite sides of the e-axle 104a.

The e-axle 104a may be an e-axle of the present disclosure and may be an axle 104 of FIG. 1. More specifically, the e-axle 104a may be the axle housing or mounting the transmission 108, the first final drive 110 and the second final drive 111 of FIG. 1. The e-axle 104a may house the electric machine 114. The e-axle 104a may drivingly couple to a first wheel 102a and a second wheel 102b. The transmission 108 is at least a two speed transmission, and may include at least a first planetary gearset (PGS) 212 and a second planetary gearset (PGS) 214. The e-axle 104a includes an axle housing 208. The axle housing 208 may house the electric machine 114 and the transmission 108. The axle housing 208 may be a compound housing comprising a plurality of axle housing components for one or more examples. Said in another way, the axle housing 208 may be an axle housing assembly comprising a plurality of axle housings. Alternatively, for other examples, the axle housing 208 may be a singular unitary structure.

The transmission 108 comprises a transmission housing 218. The transmission housing 218 may be a singular unitary structure for one or more examples. The transmission housing 218 may be a compound housing comprising a plurality of axle housing components for other examples. Said in another way, the transmission housing 218 may be a transmission housing assembly comprising a plurality of transmission housings.

The e-axle 104a may integrate and house the first final drive 110 and the second final drive 111. The e-axle 104a may also house a differential 216. The first wheel 102a may be drivingly coupled to other rotational elements of the e-axle 104a, such as the differential 216, via the first final drive 110. The second wheel 102b may be drivingly coupled to other rotational elements of the e-axle 104a, such as the differential 216, via the second final drive 111.

The e-axle 104a may include at least a first axle shaft 220 and a second axle shaft 222 that may be housed by the axle housing 208. The first axle shaft 220 may drivingly couple the first wheel 102a to the differential 216. Likewise, the second axle shaft 222 may drivingly couple the second wheel 102b to the differential 216. The first axle shaft 220 may be arranged to drivingly couple the first final drive 110 and the differential 216. The first final drive 110 may be arranged to drivingly couple the first axle shaft 220 to the first wheel 102a. For example, the first axle shaft 220 may be rigidly coupled to one or more components of the first final drive 110 and one or more components of the differential 216. The second axle shaft 222 may be arranged to drivingly couple the second final drive 111 and the differential 216. The second final drive 111 may be arranged to drivingly couple the second axle shaft 222 to the second wheel 102b. For this or another example, the second axle shaft 222 may be rigidly coupled to one or more components of the second final drive 111 and one or more components of the differential 216.

As reiterated, the electric machine 114 and the transmission 108 are integrated into the e-axle 104a, such that the electric machine may be coupled to the rotational elements of the e-axle 104a via the transmission 108, such as to drive the rotating elements of the e-axle 104a. Said in another way, the electric machine 114 may output rotational energy, such as torque, to e-axle 104a via the transmission 108. The electric machine 114 may be drivingly coupled to the differential 216 via the transmission 108, such as to drive and transmit rotational energy to the differential 216. The electric machine 114 may drive the first and second wheels 102a, 102b via the electric machine 114.

According to the exemplary embodiment shown in FIG. 2, a drive system for a vehicle, shown as e-drive 200, the transmission 108, the electric machine 114. The electric machine 114 may be and be alternatively referred to as an electromagnetic device or EM. As the first of one or more of a plurality of electric machines, the electric machine 114 may be a first electromagnetic device (EM1) that outputs torque to the e-drive 200. Other electric machines or electromagnetic devices may be referred to as EM and their number in sequence (e.g., a second electric machine may be EM2, a third electric machine may be EM3, etc.)

The e-drive 200 may be centered about an axis 206, such that the components of the e-drive 200, with exception to components of the power implements, may be centered about and radial with respect to the axis 206. The rotational elements of the e-axle 104a, the transmission 108, the electric machine 114, the differential 216, the first wheel 102a, and the second wheel 102b may be centered radially around an axis 206. The axis 206 may act as a central axis for the e-drive 200. The transmission 108 may be the transmission 108 with reference to FIG. 1. The components of the transmission 108 may be enclosed by a rectangle formed by dashed lines.

As shown in FIG. 2, the transmission 108 includes a first power transmission device or gearset, shown as the first PGS 212. The transmission also includes a second power transmission device or gearset, shown as the second PGS 214. As shown in FIG. 2, the first PGS 212 and the second PGS 214 are disposed between (e.g., sandwiched by, etc.) the electric machine 114 and the differential 216.

The first final drive 110 and the second final drive 111 may be planetary gearsets as the first and second PGSs 212, 214. More specifically the first final drive 110 and the second final drive 111 may each be of a hub drive configuration comprising at least a planetary gearset. Said in another way the first final drive 110 and/or the second final drive 111 may be hub drives. The A first brake 221 may be arranged around the first axle shaft 220. A second brake 223 may be arranged around the second axle shaft 222. The first brake 221 and the second brake 223 may be engaged (e.g. closed) to provide a counter torque via friction to the first axle shaft 220 and the second axle shaft 222, respectively. The first brake 221 and the second brake 223 may therein slow the rotational speed of and/or stop the rotation of the first axle shaft 220 and the second axle shaft 222, respectively.

The first final drive 110 may be rotationally coupled to the first wheel 102a via a first output 225. The second final drive 111 may be rotationally coupled to the second wheel 102b via a second output 227. More specifically the first final drive 110 and the second final drive 111 may be rigidly coupled to the first wheel 102a via the first output 225 and the second wheel 102b via the second output 227, respectively. One or more of a plurality of first bearings 224 may be positioned around the first output 225. Likewise, one or more of a plurality of second bearings 226 may be positioned around the second output 227. One or more of the first bearings 224 may support the first output 225, such that the first output 225 may rotate independently (e.g., freely) of the axle housing 208. One or more of the second bearings 226 may support the second output 227, such that the second output 227 may rotate independently of the axle housing 208.

The transmission 108 includes a first input 231, that may be referred to herein and act as an output of the electric machine 114. The first input 231 may be a shaft, and more specifically a connecting shaft, coupling the electric machine 114 to the transmission 108, such that the electric machine 114 may drive the rotational elements of the transmission 108. The first input 231 may be an example configuration of the first transmission input shaft 132 of FIG. 1. The first input 231 may be a hollow rotational element, such as a hollow shaft, such that the first input 231 may be positioned around one or more other rotational elements. The first input 231 may be positioned around the first axle shaft 220. The first input 231 may spin around one or more other rotational elements, that the first input 231 is positioned around. Said in another way the first input 231 may spin around one or more other rotational elements positioned concentric thereto.

The first input 231 may drivingly couple to the first PGS 212, such as to transfer rotational power, such as via torque, thereto. The first input 231 may drivingly couple to the first PGS 212 such as to transfer torque to the first PGS 212. The first input 231 may drivingly couple the electric machine 114 to the first PGS 212, such that the electric machine 114 may drive rotational elements of the first PGS 212 to rotate. A rotating element 233 may be positioned around the first input 231, where the rotating element 233 is hollow. The first input 231 and the rotating element 233 may be centered, such as to be approximately radially, around the axis 206. The first input 231 may rigidly couple to a first sun gear 232 of the first PGS 212. The first input 231 may be positioned around the first axle shaft 220. The first input 231 may drivingly couple the electric machine 114 to the first PGS 212, such that the electric machine 114 may drive rotational elements of the first PGS 212 to rotate. The electric machine 114 may generate rotational power, such as a torque, and transmit the rotational power to the first PGS 212 via the first input 231. Additionally, the electric machine 114 may generate rotational power and transmit the rotational power to the second PGS 214, via the first input or the second input and one or more components of the first PGS 212.

The first PGS 212 may be formed of the first sun gear 232, a plurality of first planetary gears 234 (e.g., first planet gears) and a first ring gear 236. The first PGS 212 may also comprise a first carrier 238, where the first carrier 238 is a gear carrier that may support one or more of the first planetary gears 234. The first sun gear 232 may mesh with the first planetary gears 234. The first planetary gears 234 may mesh with the first ring gear 236.

One or more of a plurality of third bearings 228 may be positioned around the first carrier 238 or may be positioned around at least a component rigidly coupled to the carrier 238. The one or more third bearings 228 may support the first carrier 238 and/or a component rigidly coupled thereto, allowing the first carrier 238 and the component to rotate independently of the transmission housing 218 and axle housing 208. For example, one or more of the plurality of the third bearings 228 may be positioned around and support the rotating element 233. The first carrier 238 may comprise, join to, or rigidly couple to the rotating element 233.

One or more of a plurality of fourth bearings 230 may be positioned around an axle shaft, such as the second axle shaft 222. The one or more of the fourth bearings 230 may support the second axle shaft 222 and/or components rigidly coupled thereto, allowing the second axle shaft 222 and the components to rotate independently of the transmission housing 218 and the axle housing 208.

The first planetary gears 234 may rotate with the first carrier 238 and may spin around features of the first carrier 238. The first planetary gears 234 may be supported by a plurality of bearings, with at least a bearing for each of the first planetary gears 234, where each of the bearings are around a feature of the first carrier 238 and sandwiched between the feature and a gear of first planetary gears 234. The first ring gear 236 may rigidly couple to, join to, or form from a second carrier 240. The first input 231 may drivingly couple to, join to, or form into the first sun gear 232.

A second gear clutch 239 may selectively couple the first ring gear 236 to the transmission housing 218. Additionally or alternatively, the second gear clutch 239 may selectively couple the first ring gear 236 to the axle housing 208. A second clutch input may rigidly couple or form from the first ring gear 236, and a second clutch output may rigidly couple or form from the transmission housing 218 and/or axle housing 208. When closed, the second gear clutch 239 selectively couples the second clutch input and the second clutch output. The second gear clutch 239 may be a wet clutch, and more specifically a friction clutch comprising a plurality of plates to be actuated open or closed to engage or disengage the second gear clutch 239, respectively. However, it is to be appreciated, that other types of clutches may be used for the second gear clutch 239 besides wet clutches and/or friction clutches may be used. For example, if power shifting is un-desired for the e-drive 200 or other e-drives of the present disclosure (e.g., 300, 400, and 500 of FIGS. 3, 4, and 5, respectively), the second gear clutch 239 or other second gear clutches may be dog clutches.

The second gear clutch 239 may be engaged to selectively couple the first ring gear 236 to the transmission housing 218 and/or axle housing 208, and may be disengaged to decouple the first ring gear 236 from the transmission housing 218 and/or axle housing 208. When selectively coupled and engaged, the second gear clutch 239 may rigidly couple to the transmission housing 218 and/or axle housing 208. The second gear clutch 239 acts as a brake for the first ring gear 236 of the first PGS 212, selectively fixing the first ring gear 236 to the transmission housing 218 and/or axle housing 208 when engaged, or allowing the first ring gear 236 to rotate freely of the transmission housing 218 and/or axle housing 208 when disengaged. A first component of the second gear clutch 239, such as a drum, may be rigidly coupled to a first coupling 241. The second gear clutch 239 may close and selectively couple the component to the first ring gear 236. The first coupling 241 may ground the first component to the transmission housing 218 and/or axle housing 208. When ground to the transmission housing 218 and/or axle housing 208, the first component is rigidly coupled therein. The first coupling 241 may be a fastening system or part of a fastening system, including at least a fastener or a plurality of fasteners.

The second PGS 214 may be formed of a second sun gear 242, a plurality of second planetary gears 244 (e.g., planet gears) and a second ring gear 246. The second sun gear 242 may rigidly couple to, join to, or form from the second carrier 240. The plurality of second planetary gears 244 may be supported by a third carrier 248. The second sun gear 242 may mesh with the second planetary gears 244. The second planetary gears 244 may mesh with the second ring gear 246.

The second planetary gears 244 may rotate with the third carrier 248 and may spin around features of the third carrier 248. The second planetary gears 244 may be supported by a plurality of bearings, with at least a bearing for each of the second planetary gears 244, where each of the bearings are around a feature of the third carrier 248 and sandwiched between the feature and a gear of the second planetary gears 244. The second ring gear 246 may drivingly couple to, join to, or form from a fourth carrier 250. The fourth carrier 250 may drivingly couple to the differential 216, such as to drive and transmit rotational power, such as via torque, thereto.

A first gear clutch 249 may selectively couple the third carrier 248 to the transmission housing 218. Additionally or alternatively, the first gear clutch 249 may selectively couple the third carrier 248 to the axle housing 208. A first clutch input may rigidly couple or form from the third carrier 248, and a first clutch output may rigidly couple or form from the transmission housing 218 and/or axle housing 208. When closed, the first gear clutch 249 selectively couples the first clutch input and the first clutch output. The first gear clutch 249 may be a wet clutch, and more specifically a friction clutch, comprising a plurality of plates to be actuated open or closed to engage or disengage the first gear clutch 249, respectively. However, it is to be appreciated, that other types of clutches may be used for the first gear clutch 249 that are not wet clutches or friction clutches. For example, if power shifting is un-desired for the e-drive 200 or other e-drives of the present disclosure (e.g., 300, 400, 500 of FIGS. 3, 4, 5, respectively), the first gear clutch 249 and other first gear clutches may be dog clutches.

When engaged, the first gear clutch 249 may select a first gear (e.g., a first ratio or a first speed) for the transmission 108, allowing the transmission 108 to output rotational energy, such as via a torque, at the first gear. Said in another way, the first speed of the transmission 108 may be selected by engaging the first gear clutch 249. The first gear is a different ratio from the second gear selected by the second gear clutch 239. For example, the first gear of the transmission 108 may be a gear state that has a smaller ratio and converts rotational energy into a smaller torque compared to the second gear state of the transmission 108.

The first gear clutch 249 may be engaged to selectively couple the third carrier 248 to the transmission housing 218 and/or axle housing 208, and may be disengaged to decouple the third carrier 248 from the transmission housing 218 and/or axle housing 208. When selectively coupled and engaged, the first gear clutch 249 may rigidly couple to the transmission housing 218 and/or the axle housing 208. The first gear clutch 249 may be a brake for at least a carrier of the second PGS 214. For example, the first gear clutch 249 may selectively fix the third carrier 248 to the transmission housing 218 and/or axle housing 208 when engaged, or allow the third carrier 248 to rotate freely of the transmission housing 218 and/or axle housing 208 when disengaged. A second component of the first gear clutch 249, such as a hub or a drum, may be ground to a second coupling 251. When ground to the transmission housing 218 and/or axle housing 208, the second component is rigidly coupled therein. The second coupling 251 may rigidly couple the second component to the transmission housing 218 and/or axle housing. The second coupling 251 may be a fastening system or part of a fastening system, including at least a fastener or a plurality of fasteners.

The first gear clutch 249 and the second gear clutch 239 may be spring actuated hydraulic release (SAHR) clutches. The first gear clutch 249 and the second gear clutch 239 may be actuated via changes in hydraulic pressure of a hydraulic fluid from a pump, such as the working fluid and the pump 140 of discussed in reference to and/or shown via FIG. 1. For an example, the first gear clutch 249 and the second gear clutch 239 may disengage (e.g., open) with an increase in hydraulic pressure above a first threshold of pressure. Likewise, the first gear clutch 249 and the second gear clutch 239 may engage (e.g., close) with a decrease in hydraulic pressure to or below a second threshold of pressure. The first threshold of pressure and the second threshold of pressure may be the same value of pressure.

The differential 216 may comprise a differential carrier 252, at least a first differential gear 254 and a second differential gear 256, and at least a first side gear 258 and a second side gear 260. The first side gear 258 may rigidly couple to the first axle shaft 220. The second side gear 260 may rigidly couple to the second axle shaft 222. The first differential gear 254 and the second differential gear 256 may be coupled to the differential carrier 252 such as to spin around an axis while being rotated by the differential carrier 252. Both the first differential gear 254 and the second differential gear 256 may mesh with the first side gear 258 and the second side gear 260 and transfer rotational power thereto. Unequal amounts of rotational power may be transferred from the differential carrier 252 to the first side gear 258 and the second side gear 260 via the first differential gear 254 and the second differential gear 256.

As a PGS, first final drive 110 may include at least a third sun gear 262, a plurality of third planetary gears 264 (e.g., planet gears), and a third ring gear 266. The first final drive 110 may also comprise a fifth carrier 268, where the fifth carrier 268 is a gear carrier that may support one or more of the third planetary gears 264. The third sun gear 262 may mesh with the third planetary gears 264, and the third planetary gears 264 may mesh with the third ring gear 266.

One or more of the first bearings 224 may be positioned around the fifth carrier 268 or may be positioned around at least a component rigidly coupled to the fifth carrier 268, such as the first output 225. The one or more of the first bearings 224 may support the fifth carrier 268 and/or the first output 225, allowing the fifth carrier 268 and the first output 225 to rotate independently of the axle housing 208.

The third planetary gears 264 may rotate with the fifth carrier 268 and may spin around features of the fifth carrier 268. The third planetary gears 264 may be supported by a plurality of bearings, with at least a bearing for each of the third planetary gears 264, where each of the bearings are around a feature of the fifth carrier 268 and sandwiched between the feature and a gear of the third planetary gears 264. The third ring gear 266 may rigidly couple to the axle housing 208 via a third coupling 270. The third coupling 270 may be a fastening system or part of a fastening system, including at least a fastener or a plurality of fasteners. The spinning and rotation of the third planetary gears 264 may drive the spinning of the fifth carrier 268 around the axis 206.

As a PGS, second final drive 111 may include at least a fourth sun gear 272, a plurality of fourth planetary gears 274 (e.g., planet gears), and a fourth ring gear 276. The second final drive 111 may also comprise a sixth carrier 278, where the sixth carrier 278 is a gear carrier that may support one or more of the fourth planetary gears 274. The fourth sun gear 272 may mesh with the fourth planetary gears 274, and the fourth planetary gears 274 may mesh with the fourth ring gear 276.

One or more of the second bearings 226 may be positioned around the sixth carrier 278 or may be positioned around at least a component rigidly coupled to the sixth carrier 278, such as the second output 227. The one or more the second bearings 226 may support the sixth carrier 278 and/or the second output 227, allowing the sixth carrier 278 and the second output 227 to rotate independently of the axle housing 208.

The fourth planetary gears 274 may rotate with the sixth carrier 278 and may spin around features of the sixth carrier 278. The fourth planetary gears 274 may be supported by a plurality of bearings, with at least a bearing for each of the fourth planetary gears 274, where each of the bearings are around a feature of the sixth carrier 278 and sandwiched between the feature and a gear of the fourth planetary gears 274. The fourth ring gear 276 may rigidly couple to the axle housing 208 via a fourth coupling 280. The fourth coupling 280 may be a fastening system or part of a fastening system, including at least a fastener or a plurality of fasteners. The spinning and rotation of the fourth planetary gears 274 may drive the spinning of the sixth carrier 278 around the axis 206.

A fifth coupling 282 may ground the first brake 221 to the axle housing 208. Additionally, the fifth coupling 282 may ground the first brake 221 to one or more components of the first final drive 110. When ground to a component or feature, the first brake 221 may be rigidly coupled to the component or feature. A sixth coupling 284 may rigidly couple the second brake 223 to the axle housing 208. Additionally, the sixth coupling 284 may rigidly couple the second brake 223 to one or more components of the second final drive 111. The fifth coupling 282 and the sixth coupling 284 may each be a fastening system or part of a fastening system, including at least a fastener or a plurality of fasteners. When ground to another component or feature, the second brake 223 may be rigidly coupled to the component or feature.

Optionally, a park brake functionality can be foreseen, where the e-axle 104a or other axle of the present disclosure may include at least a park brake component or a plurality of park brake components preventing rotation of the wheels 102a, 102b. The park brake functionality may be realized via at least or a combination of three different arrangements. The arrangements enabling park brake functionality are considered variants of the basic layout of an axle and driveline of the present disclosure, such as the e-axle 104a and e-drive shown in FIG. 2.

There may be one or more brakes of the e-axle 104a or other e-axles of the present disclosure that are park brakes. For an example, an axle of the present disclosure may have a dedicated park brake on the carrier of the central planetary gearset. Said in another way, the park brake may be realized using a simple pawl or any other technology.

For another example, the park brake may be an arrangement with a traditional approach of using spring applied hydraulic release (SAHR) style service brakes. For a third example, there may be a plurality of park brakes that are a first gear clutch and a second gear clutch, such as the first gear clutch 249 or the second gear clutch 239, respectively. The first and second clutches are SAHR-style (negative) clutches. Additionally or alternatively, the first brake 221 and the second brake 223 may be park brakes, engaging (closing) when the a vehicle housing the axle is parked. The first brake 221 and the second brake 223 may also be SAHR-style clutches.

The one or more park brakes may ground one or more shafts to an axle housing and/or transmission housing of the e-axle 104a or another axle of the present disclosure.

E-drive 200 shows a first power flow represented by a plurality of dashed lines 292 with arrows showing directionality. Likewise, the e-drive 200 shows a second power flow represented by a plurality of dotted lines 294. Rotational power generated, such as torque, via the electric machine 114 may follow the first power flow when the first gear clutch 249 is engaged and the second gear clutch 239 is disengaged. Rotational power, such as torque, generated via the electric machine 114 may follow the second power flow when the second gear clutch 239 is engaged and the first gear clutch 249 is disengaged.

The first power flow shows rotational power generated via the electric machine 114 may drive and rotate the input 231. The input 231 drives and rotates the first sun gear 232. When meshed with the first planetary gears 234, the first sun gear 232 rotates and drives the first planetary gears 234 around the axis 206. The second gear clutch 239 is open, allowing the first ring gear 236 to be rotated by the first sun gear 232, the first planetary gears 234, and the input 231. The first ring gear 236 may be rotated with the first sun gear 232, the first planetary gears 234, and the input 231 as a single unit. When the first sun gear 232, the first planetary gears 234, and the ring gear 236 rotate as a single unit, torque and or other rotational energy bypass the first sun gear 232. The first gear clutch 249 is closed, preventing the rotation or spinning of the third carrier 248 around the axis 206, and the second planetary gears 244 are prevented from rotating around the axis 206. When in mesh with the second ring gear 246, the second planetary gears 244 spin and the second ring gear 246 rotates and spins around the axis 206. The fourth carrier 250 rotates with the second ring gear 246, and the fourth carrier 250 drives the differential 216. More specifically, the differential carrier 252 rotates with the fourth carrier 250.

The second power flow shows rotational power generated via the electric machine 114 may drive and rotate the input 231. The input 231 drives and rotates the first sun gear 232. When meshed with the first planetary gears 234, the first sun gear 232 rotates and drives the first planetary gears 234 around the axis 206. The second gear clutch 239 is closed, grounding the first ring gear 236 to the transmission housing 218 and/or the axle housing 208, and preventing the first ring gear 236 from rotating with the first sun gear 232 and the first planetary gears 234. The first gear clutch 249 is open, allowing the rotation or spinning of the third carrier 248 around the axis 206. The first carrier 238 is driven by the rotation and spinning of first planetary gears 234, with the first carrier 238 spinning around the axis 206. The first carrier 238 and/or a input rigidly coupled, joined, or formed from therein, may drives the differential 216. More specifically, the differential carrier 252 rotates with first carrier 238 and/or the input.

Therein the disclosure provides for a configuration of an electric axle, comprising an electrified driveline, referred to herein as an e-drive. The electric axle includes at least a transmission and electric machine, where the transmission and electric machine are integrated into the e-axle. Where the e-axle and more specifically the transmission integrated therein comprises at least two planetary gearsets. Additionally, the e-axle may comprise another pair of planetary gearsets, where a final drive may include a planetary gearset of the other pair of planetary gearsets. The e-axle also houses and integrates a differential and differential gearset therein. The e-axle may include two shafts each drivingly coupled to wheels. The each of the two shaft may selectively couple to wheels via a final drive. When selectively coupled via a final drive, a shaft of the e-axle may couple one or more wheels via a planetary gearset specific to the final drive. The components of the e-axle may be housed in a housing, referred to as an axle housing.

The electric machine and the transmission may drivingly couple to the differential and differential gearset such as to transmit rotational energy, such as via torque, to the differential. For example, the electric machine may drive the differential via the transmission. For example, outputs from the transmission may couple to the differential carrier of the differential, such that the differential carrier is driven and spun via rotational energy generated via the electric machine. The rotation and spinning of the differential carrier may therein drive the differential gears and the side gears. The side gears may rigidly couple to the axle shafts of the e-axle, allowing for the driving of the wheels via the axle therein.

The transmission is a two speed transmission, having two gear speeds (e.g., gear ratios) housing a plurality of planetary gearsets with gears selectable via clutches. The clutches may be wet clutches. A first gear clutch of the clutches may be engaged to select a first gear speed for the transmission. The first gear clutch selectively fixes a first ring gear of a planetary gearset to the axle housing or deselects allowing free rotation of the planetary gearset from the axle housing. A second gear clutch may be engaged to select a second gear speed for the transmission. The first gear clutch and the second gear clutch may also be brakes for the differential, that when engaged stop the transfer of and rotation of gears of the differential therein. More specifically the first gear clutch may be a brake for the differential carrier, stopping rotation of the differential carrier.

Additional configurations of an e-drive and an e-axle of the present disclosure may be arranged for applications with a lower total driveline ratio, where the alternative configurations have single planetary gearset for the transmission. Examples e-drives and e-axles of the present disclosure having a transmission with a single planetary gearset are shown in FIGS. 3-4.

For specific packaging needs, an e-drive and an e-axle of the present disclosure may use an alternative layout of the clutches (e.g., a first gear clutch and a second gear clutch) for the transmission, where the clutches are arranged to couple rotational elements of a single planetary gearset and include a plurality of planetary gearsets. An example configuration with a two planetary gearsets with a first gear clutch and a second gear clutch specific to a single planetary gearset are shown in FIG. 5.

Further for the example configurations of e-drives and e-axles shown in FIGS. 2-5, the total driveline ratio may be increased, by arranging final drives (e.g., hub drives) to have a second stage or greater number of stages of planetary gearsets. This option is also applied in traditional axles and may be combined with an additional central planetary gearset or a plurality of additional planetary gearsets (e.g., one or more planetary gearsets of the transmission 108) as described above.

For applications where a powershift is undesired for a vehicle, such a vehicle 100, the wet clutches of the e-drives and e-axles of the present disclosure may be replaced by dog clutches.

Turning to FIG. 3 it shows a schematic of an e-drive 300. The e-drive 300 is a third example of a configuration of an e-drive of an e-axle 104b. The transmission 108 of the e-axle 104b and second configuration of drive of the present disclosure may have only planetary gearset and a first input from the electric machine 114 to drivingly couple the planetary gearset. For example, the e-drive 300 may include a configuration of the first PGS 212 with the first input 231 that may drivingly couple the electric machine 114 to the first PGS 212. The first input 231 rigidly couples the first sun gear 232.

The first PGS 212 of e-drive 300 and e-axle 104b, includes a first carrier 338 to support the first planetary gears 234. More specifically, the first planetary gears 234 may be supported by a plurality of bearings, with at least a bearing for each of the first planetary gears 234, where each of the bearings are around a feature of the first carrier 338 and sandwiched between the feature and a gear of first planetary gears 234. The first carrier 338 may rigidly couple, join to, or be form from the differential carrier 252.

The first gear clutch 342 may be an alternate example of a first gear clutch from the first gear clutch 249 of FIG. 2. The first gear clutch 342 may be SAHR clutch. When engaged (e.g., closed), the first gear clutch 342 may select the first gear speed of the transmission 108. The first gear clutch 342 may selectively couple the first ring gear 236 and the second carrier 240 to the transmission housing 218 and/or the axle housing 208. More specifically, the first gear clutch 342 selectively couples the second carrier 240 to a first hub 346, where the first hub is rigidly coupled to the transmission housing 218 and/or the axle housing 208. The first gear clutch 342 may have a first clutch input and a first clutch output. Either the first ring gear 236 or the second carrier 240 may rigidly couple to or form the first clutch input. When closed, the first gear clutch 342 selectively couples the first clutch input and the first clutch output. The first clutch output may rigidly couple to a first coupling 362.

Likewise, the transmission 108 of the e-axle 104a may include a second gear clutch 344. The second gear clutch 344 clutch may be an alternate example of a second gear clutch from the second gear clutch 239 of FIG. 2. The second gear clutch 344 may be an SAHR. When engaged, the second gear clutch 344 select the second gear speed of the transmission 108. The second gear clutch 344 may selectively couple the first sun gear 232 and the first input 231 to the first carrier 338. More specifically, the second gear clutch 344 may selectively couple a second hub 348 to the first carrier 338. The second gear clutch 344 may have a second clutch input and a second clutch output. The second hub 348 may rigidly couple to or form the second clutch input. The first carrier 338 may rigidly couple to or form the second clutch output. When closed, the second gear clutch 344 selectively couples the second clutch input and the second clutch output. The first carrier 338 of the e-drive 300 may rigidly couple to the differential carrier 252.

The first coupling 362 may ground the first hub 346 to the transmission housing 218 and/or the axle housing 208. When ground to the transmission housing 218 and/or the axle housing 208, the first hub 346 may rigidly couple transmission housing 218 and/or the axle housing 208. A second coupling 372 may ground the first brake 221 to the transmission housing 218 and/or the axle housing 208. A third coupling 374 may rigidly couple the second brake 223 to the transmission housing 218 and/or the axle housing 208. When ground to the transmission housing 218 and/or the axle housing 208, the first brake 221 and the second brake 223 may be rigidly coupled therein.

The second gear clutch 344 may selectively couple the first sun gear 232 and the first input 231 to the first carrier 338. The first carrier 338 of the e-drive 300 may rigidly couple to the differential carrier 252.

The electric machine 114 may comprise a rotor 382 and a stator 384. The rotor 382 may rigidly couple, join to, or form the first input 231. The electric machine 114 may add rotational energy in the form of torque to the first input 231 to drive the second PTO.

The e-drive 300 shows a first power flow represented by a plurality of dashed lines 392 with arrows showing directionality. Likewise, the e-drive 300 shows a second power flow represented by a plurality of dotted lines 394. Rotational power generated, such as torque, via the electric machine 114 may follow the first power flow when the first gear clutch 342 is engaged and the second gear clutch 344 is disengaged. Rotational power, such as torque, generated via the electric machine 114 may follow the second power flow when the second gear clutch 344 is engaged and the first gear clutch 342 is disengaged.

The first power flow shows rotational power generated via the electric machine 114 may drive and rotate the input 231. The input 231 drives and rotates the first sun gear 232. When meshed with the first planetary gears 234, the first sun gear 232 rotates and drives the first planetary gears 234 around the axis 206. The first gear clutch 342 is closed, grounding the first ring gear 236 and the second carrier 240, therein preventing the rotation and spinning of the first ring gear 236 and the second carrier 240. The second gear clutch 344 is open, allowing the first carrier 338 to rotate independently of the first ring gear 236 and the input 231. More specifically, the second gear clutch 344 being open allows for the first carrier 338 to rotate independently of the second hub 348. The first carrier 338 drives the differential. More specifically, the differential carrier 252 rotates with the first carrier 338.

The second power flow shows rotational power generated via the electric machine 114 may drive and rotate the input 231. The input 231 drives and rotates the first sun gear 232. When meshed with the first planetary gears 234, the first sun gear 232 rotates and drives the first planetary gears 234 around the axis 206. The first gear clutch 342 is open, allowing for the rotation of the first ring gear 236 and the second carrier 240. The second gear clutch 344 is closed selectively coupling the first carrier 338 to the input 231 and the first sun gear 232. The first sun gear 232, the first planetary gears 234, the first ring gear 236, the first carrier 338, and the second carrier 240 may rotate as a single unit, and therein torque and or other rotational energy bypass the first sun gear 232. The first carrier 338 drives the differential. More specifically, the differential carrier 252 rotates with the first carrier 338.

Turning to FIG. 4 it shows a schematic of an e-drive 400 that is a third example configuration of an e-drive having an axle of the present disclosure: an e-axle 104c. The third example of the e-drive 400 has only a planetary gearset and only a first input from the electric machine 114 to drivingly couple the planetary gearset. For example, the e-drive 400 may include the first PGS 212 with the first input 231 that may drivingly couple the electric machine 114 to the first PGS 212.

The first gear clutch 442 is an alternate example of a first gear clutch from the first gear clutch 249 of FIG. 2 and the first gear clutch 342 of FIG. 3. The first input 231 may selectively couple the first sun gear 232 via a first gear clutch 442. The first gear clutch 442 may engage (close) to selectively couple to the first sun gear 232 to the first input 231, where the first sun gear 232 and first input 231 rigidly couple. The first gear clutch 442 may disengage (open) to decouple the first sun gear 232 from the first input 231. When the first gear clutch 442 is closed and selectively couples the first sun gear 232 to the first input 231, a first gear speed may be selected for the transmission 108. Said in another way, the transmission 108 may output rotational energy, such as torque, in first gear when the first gear clutch 442 is engaged. The first gear clutch 442 may have a first clutch input and a first clutch output. The first input 231 may rigidly couple to or form the first clutch input. The first sun gear 232 may rigidly couple to or form the first clutch output. When closed, the first sun gear 232 selectively couples the first clutch input and the first clutch output.

The e-drive 400 shows the first power flow represented by the dashed lines 392 with arrows showing directionality. Likewise, the e-drive 400 shows a second power flow represented by a plurality of dotted lines 494. Rotational power generated, such as torque, via the electric machine 114 may follow the first power flow when the first gear clutch 442 is engaged and the second gear clutch 344 is disengaged. Rotational power, such as torque, generated via the electric machine 114 may follow the second power flow when the second gear clutch 344 is engaged and the first gear clutch 442 is disengaged.

The first power flow of e-drive 400 is substantially similar to the first power flow of e-drive 300. The first ring gear 236 is prevented from rotating with the first power flow of e-drive 400.

The second power flow shows rotational power generated via the electric machine 114 may drive and rotate the input 231. The first gear clutch 442 is open, allowing for the rotation of the input 231 separately from the first sun gear 232. The second gear clutch 344 is closed allowing for rotation of the first carrier 338 with the input 231. The first carrier 338 rotates and drives the first planetary gears 234 around the axis 206. The second gear clutch 344 is closed selectively coupling the first carrier 338 to the input 231 and the first sun gear 232. The first sun gear 232, first planetary gears 234, and the first carrier 338 may rotate as a single unit. When the first sun gear 232, the first planetary gears 234, and the first carrier 338 rotate as a single unit, torque and or other rotational energy bypass the first sun gear 232. The first carrier 338 drives the differential. More specifically, the differential carrier 252 rotates with the first carrier 338.

Turning to FIG. 5 it shows a schematic of an e-drive 500. The e-drive 500 is a fourth example configuration of an e-drive with an axle of the present disclosure: an e-axle 104d. The transmission 108 of e-drive 500 is two speed, has two planetary gearsets, and only a first input from the electric machine 114 to drivingly couple the planetary gearset. However, there may be a single planetary gearset of the transmission 108 of e-drive 500 having clutches.

For example, the e-drive 500 may include the first PGS 212. The first PGS 212 arranged similarly to as shown via the e-drive 300 of FIG. 3, where the first PGS 212 includes the first gear clutch 342 and the second gear clutch 344. The first input 231 may drivingly couple the electric machine 114 to the first PGS 212. The first gear clutch 342 may engage (close) to selectively couple the first ring gear 236 and the second carrier 240 to the transmission housing 218 and/or the axle housing 208. The first gear clutch 342 may disengage (open) to decouple the first ring gear 236 and the second carrier 240 from the transmission housing 218 and/or the axle housing 208. The second gear clutch 344 may engage (close) to selectively couple the first sun gear 232 and the first input 231 to the first carrier 338. The second gear clutch 344 may disengage (open) to decouple the first sun gear 232 and the first input 231 from the transmission housing 218 and/or the axle housing 208.

However, it is to be appreciated that an alternative example of the e-drive may include another arrangement of the first PGS 212. For example, the first PGS 212 may be arranged similarly to as shown in e-drive 400 of FIG. 4, where the first PGS 212 includes the first gear clutch 442 of FIG. 4 in place of the first gear clutch 342. The first input 231 may selectively couple the first sun gear 232 via a first gear clutch 442. The first gear clutch 442 may engage (close) to selectively couple to the first sun gear 232 to the first input 231, where the first sun gear 232 and first input 231 rigidly couple. The first gear clutch 442 may disengage (open) to decouple the first sun gear 232 to the first input 231.

The transmission 108 may include a second planetary gearset (PGS) 514. The second PGS 514 is absent of clutches that may selectively couple gears comprised therein to other components and features of the e-drive 500. The second PGS 514 has a second sun gear 542, a plurality of second planetary gears 544 (e.g., planet gears), and a second ring gear 546. The second ring gear 546 may be ground and rigidly coupled to the transmission housing 218 and/or the axle housing 208 via a fourth coupling 550. The plurality of second planetary gears 544 may be supported by a third carrier 548. The second sun gear 542 may mesh with the second planetary gears 544. The second planetary gears 544 may mesh with the second ring gear 546. The third carrier 548 may be rigidly couple to the differential carrier 252.

For an example, the e-axle 104d may have a first power flow and a second power flow through the first PGS 212 following the paths shown by the dashed lines 392 and the dotted lines 394 of FIG. 3, respectively. However, the first carrier 238 may rotate the second sun gear 542, driving the second PGS 514. Driving the second PGS 514 rotates and spins the second planetary gears 544, which in turn rotates the third carrier 548. The third carrier 548 may spin about the axis 206. The differential carrier 252 may rotate with the third carrier 548, driving the differential 216.

Likewise, for another example, the e-axle 104d may have a first power flow and a second power flow through the first PGS 212 following the paths shown by the dashed lines 392 and the dotted lines 494 of FIG. 4, respectively. However, the first carrier 238 may rotate the second sun gear 542, driving the second PGS 514.

E-axle arrangements of the present disclosure, such as the e-axle 104a, the e-axle 104b, the e-axle 104c, and the e-axle 104d, may be configurations of rigid axles, such as a Model 37R Rigid Planetary Axle™. An electric machine of an e-axle of the present disclosure, such as the electric machine 114, may have a rotational power output of at least 180 horse power (HP). Said in another way the electric machine 114 may be at least a 180 HP electric motor or electric motor generator. One or more of the clutches used by the e-axles of the present disclosure, such as the second gear clutch 239 and/or the first gear clutch 249 of FIG. 2, the second gear clutch 344 of FIGS. 3-5, the first gear clutch 342 of FIGS. 3 and 5, and/or the first gear clutch 442 of FIG. 4, may be eSV 604 clutches. A differential of the present disclosure, such as the differential 216, may be a differential of configurations compatible with an 37R rigid planetary axle, such as no-spin differentials, limited slip differentials, posi-torque™ differentials, hydra-Lok™ differentials, and the like. The hub drives of the present disclosure, such as the first final drive 110 and the second final drive 111, may be or include 17D wheelends.

The transmission 108 of e-axles of the present disclosure includes at least two drive mode clutches, enabling drive modes for the e-axle 104a or other e-axles of the present disclosure. Said in another way, the two drive mode clutches may enable two different gears (e.g., speeds) for the transmission. The gear clutches used by examples of the transmission 108 are the drive mode clutches. For example, the first gear clutch 249, the first gear clutch 342, the first gear clutch 442, and other examples of first gear clutches for the transmission 108 may each be a first drive mode clutch. Likewise, the second gear clutch 239, the second gear clutch 344, and other examples of second gear clutches for the transmission 108 may each be a second drive mode clutch.

FIG. 6 shows a table 600 showing a plurality of transmission states and vehicle modes that may be selected and executed via a transmission by engaging various clutches or brakes of the present disclosure. The transmission may be the transmission 108 of FIGS. 1-5. The clutches include a first gear clutch and a second gear clutch. The first gear clutch may be the first gear clutch 249 of FIG. 2 or the first gear clutch 342 of FIGS. 3 and 5, or the first gear clutch 442 of FIG. 4. The second gear clutch may be the second gear clutch 239 of FIG. 2, the second gear clutch 344 of FIGS. 3-5. The brakes may include the first brake 221 and/or the second brake 223 of FIGS. 2-5.

A first column 612 lists the clutches or brakes specific to each row, where each row labeled by the first column 612 shows states for the clutch or brake labeled for a given setting of the axle. The second column 614 shows whether a clutch or a brake listed in the first column 612 is engaged during a safe state/towing state for the transmission. During the safe state/towing state the e-axle and a vehicle including the axle may be towed while preventing degradation to components of the e-axle, such as the gears and rotational elements of an electric machine, the transmission, the differential, and/or clutches of the e-axle. The third column 616 shows whether a clutch or a brake listed in the first column 612 is engaged to provide a first gear state for the transmission. During the first gear state the transmission may output torque at a first gear speed. The fourth column 618 shows whether a clutch or a brake listed in the first column 612 is engaged to provide a second gear state for the transmission. During the second gear state the transmission may output torque at a second gear speed. The fifth column 620 shows whether a clutch or a brake listed in the first column is engaged to provide a park brake state for the transmission. There may be one or more brakes that are park brakes for the transmission. The sixth column shows whether a clutch or a brake listed in the first column is engaged to provide a hill hold state for the transmission.

As shown by the first column 612, the first row 632 shows states of a first clutch (e.g., a first gear clutch) for the vehicle during different settings, where the first clutch enables the first gear. As shown by the first column 612, the second row 634 shows states of a second clutch e.g., a second gear clutch) for the vehicle during different settings, where the second clutch that enables the second gear. As shown by the first column 612, the third row 636 shows states of brakes and park brakes of the vehicle during different settings.

During the safe state/towing state of the second column 614, the first clutch, the second clutch, and the brakes/park brakes are disengaged. During the first gear mode of the third column 616, the first clutch is engaged, but the second clutch and the brakes/park brakes are disengaged. During the second gear mode of the fourth column 618, the second clutch is engaged, but the first clutch and the brakes/park brakes are disengaged. During the park brake mode of the fifth column 620, the brakes/park brakes are engaged, but the first clutch and the second clutch are disengaged. During the hill hold mode of the sixth column 622, the first clutch, the second clutch, and the brakes/park brakes are engaged.

Turning to FIG. 7, it shows a flow chart of a method 800 for switching between different modes of operation or settings for an e-drive and an e-axle comprised therein of the present disclosure. The method 700 may be used for and performed via e-drives and e-axles of the present disclosure, such as the e-drives 200, 300, 400, and 500 and the axles 104a, 104b, 104c, and 104d, respectively. The steps of method 700 may be performed by one or more controllers, such as controller 126 of FIG. 1 or one or more other controllers, such as a control unit 921 of FIG. 9 described below. The one or more controllers may make decisions from sensor signals or user input signals, where the sensor signals may be received by one or more of a plurality of sensors, such as the sensors 128 of FIG. 1. The controller may send out one or more command signals to engage different modes of the method 700 such as gear states, brake states, hill hold states, safety states, and other modes and/or settings. More specifically, different modes of the method 700 may be engaged via one or more command signals to actuate actuators to engage or disengage the modes, such as the actuators 130 of FIG. 1.

The brakes may include the first brake 221 and the second brake 223 of FIGS. 2-5. The brakes may also include examples the first gear clutches and the second gear clutches of the of e-axles. The one or more pumps may include the pump 140 of FIG. 1. The motors(s) may include the motor 158 and/or electric machine 114 of FIG. 1. The valve block may be or include the valve block 160 of FIG. 1. Additionally or alternatively, the transmission and pump assembly using method 700 may be part of a transmission system 900 and a pump assembly 902 of FIG. 9. Likewise, the actuators and the pumps, motor, and valves actuated via the actuators for the method 700 may be of the transmission system 900 and the pump assembly 902.

Method 700 may start and proceed to 702, where the operating conditions are determined for the e-axle. Method 700 continues to 704, where the e-axle is set to a neutral state that may be referred to herein as a neutral mode.

Method 700 continues to 706, where the method 700 determines if a key of the vehicle has been turned to turn off the e-drive of the e-axle (e.g., key off). A key off may be determined by a key off signal received by a controller. The key off signal may be generated from a digital or analogue signals received from the manual input from the turning key. Additionally or alternatively, the key off signal may be digital signal from a key fob, and/or a digital or manual signal from the engagement an on/off button or other on/off input device to the vehicle. A key off command signal may additionally or alternatively refer to a first command signal sent from the controller to turn off the electric machine of the e-axle after the controller has determined key off conditions.

If the key is turned off or another key off signal has been generated (e.g., 706 is YES), method 700 continues to 708. At 708, the method 700 engages a park mode (parking mode), where the e-axle and by extension the vehicle including the axle are parked. During the park mode, a park brake or a plurality of park brakes of the e-drive and the e-axle are engaged. The park brake locks an output from the electric machine and input to a differential of the e-drive and e-axle, preventing rotation of components of the differential and axle shafts rigidly coupled thereto. Additionally or alternatively, a plurality of park brakes may be wheel side brakes that lock the axle shafts of the e-axle, preventing rotation of the axle shafts therein.

In addition to the key off command signal, there may be a first set of first command signals from a controller to one or more pumps, one or more motors driving the pump, and a valve block. The key off signal and/or the first set of command signals increase or decrease a pressure of one or more pumps, a rotational speed of one or more motors, and open or close one or more valves of a valve block to engage the brakes including one or more park brakes (parking brakes) of the vehicle.

The first set of first command signals increase or decrease the pressure of the pump(s) and rotational speed of the motor(s) and open or close valves of the valve block to engage (close) the brakes. For example, the first set of command signals may be sent to actuators of the pumps, motor, and valves changing a plurality of first hydraulic pressures to engage the brakes. For a first set of examples, the first hydraulic pressures may be decreased below a threshold to close the brakes. For a second set of examples, the first hydraulic pressures may be increased above another threshold to close the brakes.

Method 700 continues to 710, where the e-drive and e-axle are shut down. During shut down the electric machine is depowered, preventing rotation of the rotor and generation of rotational power, such as via torque. After 710, the method 700 ends.

Returning to 706, if the key is not turned off or a key off signal has been prevented from being generated (e.g., 706 is NO), method 700 continues to 712, where the method 700 determines if a safety event has occurred. A safety event may be determined via one or more sensor signals, referred to herein as safety event signals, from one or more sensors that indicate a safety event for the vehicle. A safety event may also be determined via a user input signal, also referred to herein as a safety event signal, for a safety mode, such as a towing state. The safety mode being or allowing for a towing state, allows for towing of the axle and a vehicle including the axle while preventing degradation. A controller may determine a safety event has occurred and that a sensor signal is a safety event signal, when a sensor signal or plurality of sensor signals are outside bounds of acceptable range. For example, a sensor signal may be above one or more first thresholds. At or above the one or more first thresholds, the sensor signal is determined as a safety event signal via the controller. For another example, the sensor signal may be above one or more second thresholds. At or above the one or more second thresholds, the sensor signal is determined as a safety event signal via the controller. In response to one or more safety event signals, the controller sends out a second command signal to engage a safe state, and the second command signal may be referred to a safety state command signal.

If a safety event does occur (712 is YES), method 700 continues to 714. At 714, the method 700 transitions the e-axle to the safe state. At the safe state the gear clutches of the e-axle decouple, preventing transfer of rotational power through the first planetary gearset and the second planetary gearset to the differential. During the safe state the first gear clutch, the second gear clutch, and the brakes, including one or more park brakes, are disengaged. After 714, the method may return to 806 and determine if the key has been turned to turn off the e-drive of the e-axle.

In addition to the safety state command signal, there may be a second set of second command signals from the controller to one or more pumps, one or more motors driving the pump, and a valve block. The safety state command signal and/or the second set of second command signals increase or decrease the pressure of the pump(s), the rotational speed of the motor(s), and open or close valves of the valve block to disengage (open) the first gear clutch, the second gear clutch, and the brakes of the e-axle. For example, the second set of second command signals may be sent to actuators of the pumps, motor, and valves changing a plurality of first hydraulic pressures to disengage the first gear clutch, the second gear clutch, and the brakes. For a first set of examples, the first hydraulic pressures may be increased above at least a first threshold to open the brakes, and a second threshold to open the first gear clutch and the second gear clutch. For a second set of examples, the first hydraulic pressures may be decreased below at least the first threshold to open the brakes, and the second threshold to open the first gear clutch and the second gear clutch.

Returning to 712, if a safety event does not occur (712 is NO), method 700 continues to 722. At 722, the method 700 determines if a driver and/or another occupant of the vehicle selects a drive mode of operation. The driver and/or occupant may select the drive mode of operation via an input, such as a lever and/or peddle, or another input device, such as a set of buttons or knobs. For an example, the selection of the drive mode may be sent as an input signal to the controller. In response to the input signal, the controller sends a third command signal to engage the drive mode. For another example, the selection of the drive mode may be an analogue signal from the input. The third command signal or the analogue signal may be referred to herein as a drive mode signal. The drive mode signal engages the axle in the drive mode of operations. If a drive mode of operation is not selected (e.g., 722 is NO), the method 700 continues returning to 704. If a drive mode of operation is selected (e.g., 722 is YES), method 700 continues 724 where the drive operations begin, selecting and operating specific drive operations and gears of the transmission of the e-axle. After and during drive operations of 724, the method 700 continues to 726.

At 726, the method 700 determines if a safety event has occurred during the driving operations of 724. If a safety event has occurred (e.g., 726 is YES), method 700 continues to 714 where the e-axle is placed in a safe state. If a safety event has not occurred (e.g., 726 is NO), method 700 continues to 728.

At 728, the method 700 determines if a hill hold event has occurred. A hill hold event may occur via detection by sensors or other inputs. Likewise, a hill hold event may occur when an operator or another occupant of a vehicle sends a manual signal to engage the hill hold feature and mode of the vehicle provided via the e-axle. An input signal delivers the detection to the controller. The controller determines the input signal is for the hill hold event, and the controller to send a fourth command signal for a hill hold event. Alternatively, the input signal may be an analogue signal separate from the controller. The fourth command signal or the analogue signal may be referred to as a hill hold command signal. If a hill hold event has not occurred (e.g., 728 is NO), method 700 returns to 724 and driving operations continue. If a hill hold event has occurred (e.g., 730 is YES), method 700 continues to 730.

At 730, the method 700 places the e-drive and the e-axle in a hill hold mode. During the hill hold mode, the first gear clutch, the second gear clutch, and the brakes, including the one or more park brakes, of the e-axle and the e-drive therewithin are engaged. After 730, method 700 continues to 732.

In addition to the hill hold command signal, there may be a third set of third command signals from the controller to one or more pumps, one or more motors driving the pump, and a valve block. The hill hold command signal and/or the third set of third command signals increase or decrease the pressure of the pump(s), the rotational speed of the motor(s), and open or close valves of the valve block to engage (close) the first gear clutch, the second gear clutch, and the brakes of the e-axle. For example, the third set of third command signals may be sent to actuators of the pumps, motor, and valves changing the first hydraulic pressures to engage the first gear clutch, the second gear clutch, and the brakes. For a first set of examples, the first hydraulic pressures may be decreased below the first threshold to close the brakes, and the fourth threshold to close the first gear clutch and the second gear clutch. For a second set of examples, the first hydraulic pressures may be increased above at least the first threshold to close the brakes, and the second threshold to close the first gear clutch and the second gear clutch.

At 732, the method 700 determines if a safety event has occurred during the hill hold mode and operations of 732. If a safety event has occurred (e.g., 732 is YES), method 700 continues to 714 where the e-axle is placed in a safe state. If a safety event has not occurred (e.g., 732 is NO), method 700 continues to 734.

At 734, the method 700 determines if another drive command signal, such as a fifth command signal from the controller and/or from a driver or another occupant of the vehicle, to reengage the drive operations of 724. If drive operations have been reengaged (e.g., 734 is YES), the method 700 returns to 724. If drive operations have been prevented from reengaging, (e.g., 734 is NO), the method 700 continues to 736.

At 736, the method 700 determines if a sixth command signal has been sent by the controller, and/or the driver or another occupant of the vehicle to select the neutral mode for the e-axle. If the neutral mode is selected (e.g., 736 is YES), method 700 continues and returns to 704. If the neutral mode is not selected (e.g., 736 is NO), method 700 continues and returns to 730, where the e-axle remains in the hill hold mode.

Turning to FIG. 8, it shows a flow chart of a method 800 for switching between different operational modes of the drive mode for an e-drive and an e-axle comprised therein of the present disclosure. The method 800 may be used for e-drives 200, 300, 400, 500 and axles 104a, 104b, 104c, 104d, respectively.

Method 800 begins at 708 of FIG. 7 and continues to 802, where a starting gear is selected. At 802 the method selects between transitioning a transmission of the e-drive to select a first gear (e.g., first speed) or a second gear (e.g., second speed). If the first gear is selected, the method 800 may continue to 804, where the first gear is selected by the transmission. At least a first command signal from the controller and/or from a driver or another occupant of the vehicle may select the transmission to run in the first gear. The first command signal may be referred to herein as the first gear signal. The first gear signal causes a first gear clutch of the e-axle to engage (close) and a second gear clutch of the e-axle to disengage (open).

In addition to the first gear signal, there may be a first set of first command signals from a controller to one or more pumps, one or more motors driving the pump, and a valve block. The first command signal or the first set of command signals increase or decrease the pressure of the pump(s) and rotational speed of the motor(s) and open or close valves of the valve block to engage the first clutch and disengaged the second clutch. The one or more pumps may include the pump 140 of FIG. 1. The motors(s) may include the motor 158 and/or electric machine 114 of FIG. 1. The valve block may include the valve block 160 of FIG. 1. A plurality of actuators used to actuate the pumps, motor, and valves, may be some of the actuators 130 of FIG. 1. Likewise, the actuators and the pumps, motor, and valves actuated via the actuators for the method 800 may be of the transmission system 900 and the pump assembly 902. The first set of first command signals increase or decrease the pressure of the pump(s), rotational speed of the motor(s), and open or close valves of the valve block to engage the first clutch and disengaged the second clutch. For example, the first set of signals may be sent to actuators of the pumps, motor, and valves changing a first hydraulic pressure to engage the first clutch and changing a second hydraulic pressure disengage the second clutch. For a first set of examples, the first and second hydraulic pressures may be decreased below a first threshold of pressure to close and increase above a second threshold of pressure to open the first clutch and close the second clutch. For a second set of examples, the first and the second hydraulic pressures may be increased above a third threshold of pressure to close and decrease below a fourth threshold of pressure to open the first clutch and close the second clutch.

If the second gear is selected (e.g., Second Gear), the method 800 may continue to 806, where the second gear is selected by the transmission. A second command signal from the controller and/or from a driver or another occupant of the vehicle may select the transmission to run in second gear. The second command signal may be referred to herein as the second gear signal. The second gear signal causes a first gear clutch of the e-axle to disengage (open) and a second gear clutch of the e-axle to engage (close).

In addition to the second gear signal, there may be second set of second command signals from the controller to the one or more pumps, the one or more motors driving the pump, and the valve block. The second set of second command signals increase or decrease the pressure of the pump(s), rotational speed of the motor(s), and open or close valves of the valve block to disengage the first clutch and engage the second clutch. For example, the second set of second command signals may be sent to the actuators of the pumps, motor, and valves changing the first hydraulic pressure to disengage the first clutch and changing the second hydraulic pressure disengage the second clutch.

From 804, the method 800 continues to 812, where a gear change event from the first gear is determined. Said in another way, the method 800 evaluates whether there is a desire to change gears from the first gear. The desire to change gears from the first gear may be determined by receiving the second gear signal. If there is a desire to change gears from the first gear (e.g., YES), method 800 continues to 806, where the transmission transitions the e-axle into the second gear. If there is no desire to change gears from the first gear (e.g., 812 is NO), the e-axle remains in the first gear and method 800 ends.

From 806, the method 800 continues to 814, where a gear change event from the second gear is determined. Said in another way, the method 800 evaluates whether there is a desire to change gears from the second gear. The desire to change gears from the second gear may be determined by receiving the first gear signal. If there is a desire to change gears from the second gear (e.g., YES), method 800 continues to 804, where the transmission transitions the e-axle into the first gear. If there is no desire to change gears from the second gear (e.g., 814 is NO), the e-axle remains in the second gear and method 800 ends.

Therein the disclosure provides for a method for switching between different modes of operation for the e-axle. Modes of operation include a mode for engaging the e-axle in a neutral state, a mode of driving operation, a mode for engaging a hill hold feature, modes engaging a safe state and/or towing state, and a mode for engaging a park brake. The towing state may be a disconnect mode, where no clutches are engaged and the wheels of an axle may rotate independently of the axle shafts, gears of the differential, and the gears of the transmission. The method also includes selecting between different gear modes during a driving operation.

Said in another way, the disclosure provides for a method of switching between different modes of operation for an electric axle comprising: setting an axle in a neutral mode, transitioning an e-axle to drive mode, via engaging a first clutch or a second clutch, where the first clutch and the second clutch are clutches of at least a planetary gearset, where engaging the first clutch enables a first speed, and engaging the second clutch enables a second speed for a transmission rigidly coupled to and outputting to the electric axle, transitioning the electric axle to a hill hold mode when a hill hold command signal or event is detected via engaging the first clutch, the second clutch, and one or more brakes, transitioning the electric axle into park mode when a key off signal or event is detected via engaging the one or more brakes, sending a first set of command signals from a controller to a hydraulic pump and a valve block to engage the first clutch, the second clutch, and the one or more brakes, and sending a second set of command signals from the controller to the hydraulic pump and the valve block to disengage the first clutch, the second clutch, and the one or more brakes. In a first example of the method, during the drive mode, the method comprises engaging the first clutch and disengaging the second clutch in response to a first command signal for a first gear mode, and engaging the second clutch and disengaging the first clutch in response to a second command signal for a second gear mode.

Turning to FIG. 9, it shows an example of a pump assembly 902 that may be included in a transmission system 900. The transmission system 900 and pump assembly 902 may be included in a vehicle, such as the vehicle 100 of FIG. 1. Said in another way, the pump assembly 902 may be an example arrangement of the pump assembly 139 of FIG. 1. Likewise, the transmission system 900 may include or be a transmission of the vehicle 100, such as the transmission 108 of FIGS. 1-5. The working fluid in the system may be oil, as previously discussed in reference to the pump assembly 139 and dotted lines 144 representing fluid flow of FIG. 1. The transmission system 900 and the pump assembly 902 may be shown with a plurality of flow path represented via solid lines with arrows in FIGS. 10A-10B, where the flow paths may show the directional flow of working fluid, such as oil. Further, the control system 124, shown in FIG. 1, may be used to adjust the controllable components in the transmission system depicted in FIGS. 9-10B.

Turning to FIG. 10A, it shows an example of the pump assembly 902 and transmission system 900 in a first state, where components of the pump assembly 902 are arranged to allow for fluid flow of working fluid via a first flow path 1000 and a second flow path 1002.

Turning to FIG. 10B, it shows an example of the pump assembly 902 and transmission system 900 in a second state, where components of the pump assembly 902 are arranged to allow for fluid flow of working fluid via a third flow path 1004 and a fourth flow path 1006.

FIGS. 9-10B, may be discussed interchangeably below.

The pump assembly 902 includes the motor 158 that drives a first pump 906, a second pump 908, and a third pump 910 via a drive shaft 912. Each of the first, second, and third pumps 906, 908, and 910 are hydraulic pumps. Each of the first, second, and third pumps 906, 908, and 910 may be fixed displacement pumps. In such an example, the displacement of each of these pumps may vary. For instance, the first pump 906 may have a greater displacement than the second pump 908, and the second pump 908 may have a greater displacement than the third pump 910. In this way, the size of the pumps may be selected to meet the granular flow demands of a lubrication circuit and an actuation circuit, such as the lubrication circuit 154 and an actuation circuit 156. As previously discussed, the lubrication circuit 154 provides oil or other working fluid suitable for use as a lubricant to moving components, such as bearings, gears, clutches, and the like, where the working fluid lubricates the moving components. Likewise, the actuation circuit 156 provides oil or other suitable working fluid for use as a hydraulic fluid to adjustable components in the transmission, such as clutches, brakes, shift rails, and the like. The change in pressure of the working fluid to pressure chambers and other fluid volumes within the actuation circuit 156 specific to one or more adjustable components, may actuate the one or more adjustable components therein. For example, the clutches of a transmission, such as the transmission 108 or another example of a transmission of the transmission system 900, may be wet friction clutches that are designed to shift the transmission between discrete gears. It is to be appreciated, that wet friction clutches includes friction plates that allow torque transfer through the clutch to be modulated.

Types of fixed displacement pumps that may be used for the pumps 906, 908, and 910 may include external gear pumps in which two gear are used to increase the pressure of the fluid flowing therethrough. Due to the simplicity of the external gear pumps, development of the pump assembly is simplified due to a reduction in the effort devoted to integration of the pumps into the system, when compared to variable displacement pumps. The applicability of the pump assembly is therefore expanded to a wider variety of vehicles which increases customer appeal.

The motor 158 may receive electric power from an energy storage device 918 by way of an inverter 920. For an example, the energy storage device 918 may be the traction battery 120 shown in FIG. 1. The inverter 920 may receive control commands from the controller which adjusts the speed of the drive shaft 912 and therefore the flowrate of the pumps. The inverter 920 may include a control unit 921 which electronically communicates with another control unit such as a TCU. The control unit 921 include circuitry such as a processor, memory, input/output ports, and the like. The control unit 921 may be the controller 126 or another controller of control system 124 shown in FIG. 1. However, in other examples, the inverter 920 may be omitted.

For an example of another arrangement, the electric machine 114 of FIGS. 1-5 may be used in place of the motor 158. Therein, the drive shaft 912 may be an output of the electric machine 114, such as the rotating element 233. Said in another way, the drive shaft 912 may be a hollow shaft or another configuration of shaft rigidly coupled to rotor 382 of FIGS. 3-5 and/or driven by the electric machine 114.

The motor 158 may be designed to run at a selected regime speed. For an example of a use case, 1,000 revolutions per minute (RPM). For another example of a use case, 1,200 RPM. For another example of a use case, 1,500 RPM. The regime speed may be selected to allow the pumps to meet flowrate demands of the lubrication circuit when a shift event is not occurring. Therefore, the regime speed may be selected based on factors such as the displacement of the pumps, the lubrication needs of the transmission components, the lubrication system layout, and the like. The motor 158 may also be designed to operate at higher speeds. To elaborate, during shift events the motor 158 may be operated at a higher speed (e.g., peaked) for a comparatively short duration to meet the flow demands of the actuation circuit during the shift. The motor peaking events represent a comparatively small percentage of the operational time from the transmission system. The transmission system and specifically the pump drive will operate in the regime condition for a considerably longer duration.

It is to be appreciated, that the motor 158 has a certain thermal capacitance over a threshold of thermal capacitance, allowing the motor 158 to produce more torque and power during a certain time period prior to reaching an over-temperature condition at a temperature at or above a temperature threshold (e.g., overheating). Therefore, the electric motor which drives the pumps may be downsized along with the inverter 920 to reduce the weight and complexity of the system while increasing system efficiency. However, while the motor is operated at these higher speeds and with sustained/higher torque (i.e., higher power), the motor temperature may be monitored to reduce the chance of motor thermal degradation. For instance, the rotational speed of the motor 158 may be reduced when the motor temperature (e.g., the temperature of the motor 158) exceeds a threshold value of temperature. The threshold value of temperature (e.g., a temperature threshold) is indicative of motor component degradation to the motor 158. Said in another way at or above the threshold value of temperature, components of the motor 158 may begin degrading chronically at faster and undesired rates compared to below the threshold value of temperature and/or begin degrading acutely at other undesired rates. In this way, the motor 158 can be downsized but controlled to reduce degradation during peaking events via reducing periods of time where the motor operates at or above the threshold value of temperature.

A fluid reservoir 922 (e.g., sump) is further included in the pump assembly 902. Fluid lines 924 provide fluidic communication between the fluid reservoir 922 and the pumps 906, 908, and 910 which extend therebetween. To elaborate, the lines 924 are coupled to inputs 926, 928, and 930 of the first, second, and third pumps 906, 908, and 910, respectively. A filter 932 may be included in the line which extends into the reservoir. However, the filter may be omitted from the system in other arrangements, configurations, or other embodiments of the pump assembly 902 or another pump assembly of the present disclosure. Additionally, a return line 934 that may be in fluidic communication with the lubricated components and adjustable components which correspond to the lubrication circuit 154 and the actuation circuit 156. In this way, oil or other working fluid may be circulated through the system.

The pumps 906, 908, and 910 include outlets 936, 938, and 940 respectively. The outlet 936 of the first pump 906 is in fluidic communication with the lubrication circuit 154 via a line 942 and the outlet 940 of the third pump 910 is in fluidic communication with the actuation circuit 156 via line 944.

A valve 946 is positioned in a cross-over line 948 which connects the outlet 936 of the first pump 906 with the outlet 938 of the second pump 908. The valve 946 includes a solenoid 950 designed to change the state of the valve 946. In an open state, shown in FIGS. 9 and 10A, the valve permits fluid flow between the outlet 938 of the second pump 908 and the line 942 which connects the outlet 936 of the first pump 906 and the lubrication circuit 154. Conversely, in a closed state, shown in FIG. 10B, the valve inhibits fluid flow between the outlet 938 of the second pump 908 and the line 944 which connects the outlet 936 of the first pump 906 and the lubrication circuit 154.

In the illustrated examples of FIGS. 9-10B, the valve 946 may be in an open position when the solenoid 950 is de-energized and conversely may be in a closed state when the solenoid 950 is energized. A spring 952 allows the valve to return to the open position when the solenoid is de-energized. However, other valve actuation schemes have been contemplated. For instance, energization of the solenoid may place the valve in its open position, in alternate embodiments.

A check valve 954 is positioned in a cross-over line 956 which connects the outlet 938 of the second pump 908 with the outlet 940 of the third pump 910. The check valve 954 is designed to permit fluid flow between the outlet 938 of the second pump 908 and the line 944 which connects the outlet 940 of the third pump 910 to the actuation circuit 156 when the pressure in the cross-over line 956 exceeds a threshold value of pressure (e.g., pressure threshold). For a use case example, the pressure threshold may be 1 bar. For another use case example, the pressure threshold may be 3 bar. For another use case example, the pressure threshold may be 5 bar. The check valve may be designed with a relatively low opening pressure to reduce losses.

In the illustrated example, a temperature sensor 958 is coupled to the fluid reservoir 922 and a current sensor 960 is coupled to the inverter 920. There may be a plurality of temperature sensors 958. There may be a plurality of current sensors 960. At least a temperature sensor 962 may also be coupled to the motor 158. There may be a plurality of temperature sensors 962. The temperature sensors 962 may send signals to the controller 126 of FIG. 1 and/or the control unit 921. The temperature sensors 958, the current sensors 960, and/or the temperature sensors 962 may be sensors of the sensors 128 of FIG. 1. In other examples, different sensor arrangements may be used in the system.

FIGS. 10A and 10B show the transmission system 900 and the pump assembly 902 with the valve in different configurations that provide different flowrates to the lubrication circuit 154 and the actuation circuit 156.

In FIG. 10A the first flow path 1000 between the reservoir 922 and the lubrication circuit 154 is indicated along with the second flow path 1002 between the reservoir and the actuation circuit 156. In FIG. 10A the inverter 920 is operated to drive the motor 158 at a regime speed (e.g., at or above a threshold of rotational speed for producing a desired flow regime of working fluid from the pumps 906, 928, 930), the valve 946 is in an open configuration that enables oil flow in the cross-over line 948, and the check valve 954 is closed. As shown, fluid from the outlets of the first pump 906 and second pump 908 is delivered to the lubrication circuit 154. Likewise, fluid from the outlet of the third pump 910 is delivered to the actuation circuit 156. In this way, the valve 946 is operated to flow a desired amount of oil to the lubrication circuit 154 while a decreased amount of oil flow to the actuation circuit 156. In the arrangement of the state shown in FIG. 10A, both the first pump 906 and the second pump 908 are working together and are providing the required flow to the lubrication circuit 154. In the arrangement of the state shown in FIG. 10A, the third pump 910 functions as a stand-alone pump and is providing fluid to the actuation circuit 156 at a flowrate that compensates for the losses in the actuation circuit 156. By design, the pump assembly 902 may be sized such that the lubrication circuit 154 and the actuation circuit 156 receive a targeted amount of oil at the selected regime speed which reduces losses in the system.

In FIG. 10B, the third flow path 1004 between the reservoir 922 and the lubrication circuit 154 is indicated along with the fourth flow path 1006 between the reservoir and the actuation circuit 156. Further, in FIG. 10B the inverter 920 is operated to drive the motor 158 at a higher speed compared to in FIG. 10B, the valve 946 is in a closed configuration that inhibits oil flow in the cross-over line 948, and the check valve 954 opens to allow oil flow through the cross-over line 956.

As shown in FIG. 10B, fluid from the outlet of the first pump 906 is delivered to the lubrication circuit 154 while fluid from the outlets of the second pump 908 and the third pump 910 is delivered to the actuation circuit 156 due to the fact that the pressure increase in the cross-over line causes the check valve 954 to open. In this way, the valve 946 may be strategically adjusted to meet flow demands of the actuation circuit 156 during transient conditions (e.g., shift events).

During shift events, one or more clutches and/or brakes. For one or more examples, the second gear clutch 239 and/or the first gear clutch 249 of FIG. 2, the second gear clutch 344 of FIGS. 3-5, the first gear clutch 342 of FIGS. 3 and 5, and/or the first gear clutch 442 of FIG. 4 may be actuated to engage or disengage (e.g., open or close, respectively) during shift events. Additionally or alternatively, for one or more examples, the first brake 221 and/or the second brake 223 may be actuated to engage or disengage during shift events.

For example, a first set of command signals from a controller, such as the controller 126 of FIG. 1 and/or the control unit 921, may open a plurality of first valves and a plurality of second valves of a valve block, such as the valve block 160 of FIG. 1. The change in hydraulic pressure via the opening of the first valves and closing of the second valves may close a first clutch and open a second clutch to transition a transmission, such as the transmission 108 of FIGS. 1-5, to a first gear (e.g., a first speed). For another example, a second set of command signals from the controller, may close the first valves and open the second valves of the valve block. The change in hydraulic pressure via the opening of the first valves and closing of the second valves may open the first clutch and close the second clutch to transition the transmission to a second gear (e.g., a second speed). For these examples, the first clutch may be the first gear clutch 249 of FIG. 2, the first gear clutch 342 of FIGS. 3 and 5, or the first gear clutch 442 of FIG. 4. For these examples, the second clutch may be the second gear clutch 239 of FIG. 2 or the second gear clutch 344 of FIGS. 3-5.

FIGS. 1-5 and FIGS. 9-10B show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

It will be appreciated that the configurations and routines disclosed herein are exemplary in nature, and that these specific embodiments are not to be considered in a limiting sense, because numerous variations are possible. Moreover, unless explicitly stated to the contrary, the terms “first,” “second,” “third,” and the like are not intended to denote any order, position, quantity, or importance, but rather are used merely as labels to distinguish one element from another. The subject matter of the present disclosure includes all novel and non-obvious combinations and sub-combinations of the various systems and configurations, and other features, functions, and/or properties disclosed herein.

As used herein, the term “approximately” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A configuration of an electric axle comprising:
a first clutch configured to ground a ring gear in a first planetary gearset;
a second clutch configured to:
ground a carrier in a second planetary gearset; and
drivingly couple an input of the first planetary gearset to an output of the second planetary gearset to bypass the first planetary gearset;
one or more park brakes configured to ground one or more shafts to an axle housing of the electric axle; and
a controller configured to:
in a hill hold mode, engage the first clutch, the second clutch, and the one or more park brakes;
and in disconnect mode, disengage the first clutch, the second clutch, and the one or more park brakes, where the disconnect mode is a towing state allowing for towing.

2. The electric axle of claim 1, wherein the electric axle only includes two drive mode clutches.

3. The electric axle of claim 2, wherein the electric axle further comprises a hydraulic valve block configured to hydraulically control the first clutch, the second clutch, and the one or more park brakes.

4. The electric axle of claim 1, wherein the electric axle is integrated into an electrified vehicle.

5. The electric axle of claim 4, wherein the electric axle is integrated into a fully electric vehicle.

6. The electric axle of claim 1, wherein a transmission is integrated therein, and the transmission includes the first planetary gearset and the second planetary gearset.

7. The electric axle of claim 1, wherein an electric machine rigidly couples to the input to the first planetary gearset.

8. The electric axle of claim 7, where the input rigidly couples to a second carrier of the first planetary gearset.

9. The electric axle of claim 7, wherein the electric machine is integrated into the electric axle, such that the electric machine is mounted to and rigidly coupled to the electric axle.

10. A configuration of an electric axle comprising:
a first clutch that selectively couples a first planetary gearset to a transmission component of the electric axle via closing a first clutch input and a first clutch output;
a second clutch that selectively couples a first carrier in the first planetary gearset via closing and selectively coupling a second clutch input and a second clutch output, and drivingly couples an input of the first planetary gearset to a differential carrier to bypass a first sun gear of the first planetary gearset;
one or more park brakes configured to ground one or more shafts to an axle housing of the electric axle; and
a controller that, in a hill hold mode, engages the first clutch, the second clutch, and the one or more park brakes and, in disconnect mode, disengages the first clutch, the second clutch, and the one or more park brakes, where the disconnect mode is a towing state.

11. The electric axle of claim 10, where the first clutch grounds a ring gear of the first planetary gearset to the axle housing, where the first clutch input rigidly couples to the ring gear and the first clutch output grounds to the axle housing.

12. The electric axle of claim 11, where the first clutch selectively couples a hub to the ring gear, where the hub is the first clutch output and grounds to the axle housing of the electric axle.

13. The electric axle of claim 12, where the hub rigidly couples and grounds to a transmission housing.

14. The electric axle of claim 10, where the first clutch selectively couples a sun gear of the first planetary gearset to the input to the first planetary gearset, where the first clutch input rigidly couples to the input and the first clutch output rigidly couples to the first planetary gearset, and a ring gear of the first planetary gearset rigidly couples the axle housing.

15. The electric axle from claim 10, where the first clutch and the second clutch are wet clutches.

16. The electric axle of claim 10, where the electric axle includes a second planetary gearset arranged between the first planetary gearset and the differential carrier, where the first carrier is configured to rigidly couple a second sun gear of the second planetary gearset.

17. The electric axle of claim 16, where a second carrier of the first planetary gearset is arranged to rigidly couple the differential carrier.

18. The electric axle of claim 10, wherein an electric machine is integrated into the electric axle, such that the electric machine rigidly couples the input arranged to drive the first planetary gearset, and the electric machine is mounted to and rigidly coupled to the electric axle.

19. A method of switching between different modes of operation for an electric axle comprising:
setting an axle in a neutral mode;
transitioning an e-axle to drive mode, via engaging a first clutch or a second clutch, where the first clutch and the second clutch are clutches of at least a planetary gearset, where engaging the first clutch enables a first speed, and engaging the second clutch enables a second speed for a transmission rigidly coupled to and outputting to the electric axle;
transitioning the electric axle to a hill hold mode when a hill hold command signal or event is detected via engaging the first clutch, the second clutch, and one or more brakes;
transitioning the electric axle into park mode when a key off signal or event is detected via engaging the one or more brakes;
sending a first set of command signals from a controller to a hydraulic pump and a valve block to engage the first clutch, the second clutch, and the one or more brakes; and
sending a second set of command signals from the controller to the hydraulic pump and the valve block to disengage the first clutch, the second clutch, and the one or more brakes.

20. The method of claim 19, wherein during the drive mode, the method comprises engaging the first clutch and disengaging the second clutch in response to a first command signal for a first gear mode, and engaging the second clutch and disengaging the first clutch in response to a second command signal for a second gear mode.
